(19) United States
(12) Patent Application Publication
(10) Pub. No.: US 2014/0311414 A1
(43) Pub. Date: Oct. 23, 2014

(54) Animal Waste Disposal System and Method

(71) Applicant: William Morris, Orlando, FL (US)

(72) Inventor: William Morris, Orlando, FL (US)

(21) Appl. No.: 14/205,561

(22) Filed: Mar. 12, 2014

Related U.S. Application Data
(60) Provisional application No. 61/777,436, filed on Mar. 12, 2013.

(51) Int. Cl. A01K 23/00

(52) U.S. Cl. CPC A01K 23/005
USPC 119/161

(57) ABSTRACT

An apparatus for packaging animal waste. In one embodiment, a platform has a surface over which waste may be deposited, and a pair of rollers positioned along an edge of the platform to receive a receiving substrate and a cover substrate, each substrate having first and second opposing edge regions. A first dispensing mechanism is positioned to provide the receiving substrate across the platform to the rollers; and a second dispensing mechanism is positioned to deliver the cover substrate to the rollers. Each roller is positioned to receive the edge regions of the receiving substrate and the cover substrate and press the edge regions of each against the other to join the edge regions together.

### RELATED APPLICATIONS

This application claims priority to U.S. Provisional Patent Application Ser. No. 61/777,436, filed Mar. 12, 2013 which is incorporated herein by reference.

### FIELD OF THE INVENTION

The present invention relates to animal waste disposal and, more particularly, to methods and an apparatus for disposal of animal waste.

### BACKGROUND OF THE INVENTION

The invention relates to pets, especially dogs, and a need to provide sanitary waste removal suitable for an indoor environment. While it is common place to provide pets with access to an outdoor environment, e.g., by taking a dog for a walk, in many places it is a requirement that animal waste be promptly collected for sanitary and socially acceptable disposal. Further, there are a large number of factors which render it inconvenient or impractical to bring a pet outdoors. These factors include weather conditions, safety and situations where the owner is incapacitated or otherwise unable to provide for the needs of the pet. A pet owner may also need to be away from the home (e.g., for employment reasons or to fulfill other commitments), thereby leaving the pet without a human companion for an extended period of time. This may present a hardship for the animal or result in an unsanitary deposit in an unacceptable location, requiring undesirable collection and cleaning. In the best of circumstances, a pet can be trained to use specific locations for depositing waste material but this may remain unappealing, particularly in view of odors and the fact that pet waste is not easily isolated from a living environment. Although a pet may consistently make use of a litterbox, an odor may nonetheless be present, the waste will have to be removed and the litterbox may need to be cleaned on a regular basis. Consequently, there is a need to provide a system and method for waste removal which are suitable for use in a residential setting, and which facilitate provision of a sanitary and odor free environment.

### SUMMARY OF THE INVENTION

According to one series of embodiments, the invention is an apparatus for packaging animal waste which includes a platform having a single and continuous receiving region surface over which waste may be deposited and a pair of spaced apart rollers. Each roller is positioned along an edge of the platform (i) to receive, between each roller and along the entire receiving region surface, as the rollers turn, a receiving substrate having first and second opposing edge regions and (ii) to receive a cover substrate also having first and second opposing edge regions. The apparatus includes a first mechanism positioned to dispense the receiving substrate for movement across the platform to the rollers, and a second mechanism positioned to dispense the cover substrate for movement to the rollers without the cover substrate moving along the receiving region. Each roller is positioned to simultaneously receive the edge regions of both the receiving substrate and the cover substrate as the rollers turn and press the edge regions of the cover substrate against the edge regions of the receiving substrate to bond the edge regions together. In one embodiment, the rollers are positioned to press the edge regions together with pressure. The rollers may be resiliently biased toward a stationary surface. The platform may include a press plate extending under the rollers, and the apparatus may further comprise a belt drive system for turning the rollers. The belt drive system may include a bias component, that transfers a force to the rollers, which displaces the rollers against the press plate. The apparatus may include a repository into which the rollers direct the joined receiving and cover substrates. The platform may be adjustable in length and may include a sensor which detects presence of a pet on the platform. The apparatus may include a transverse pressing mechanism configured to periodically bond together a portion of the receiving substrate, between the receiving substrate edge regions, and a portion of the cover substrate between the cover substrate edge regions. The periodic motion may be caused by a cam system comprising a rotatable cam and a rocker arm having a first end biased against an edge of the cam. The cam system may comprise a transverse member and the periodic motion may be caused by a cam, the cam system moving the transverse member to cause a transverse convergence. The cam system may include a rotatable cam and a rocker arm having a first end biased against an edge of the cam. The rocker arm may include a second end associated with the transverse member. The association may include a resilient safety member that biases the transverse member to move with the second end. The apparatus may also include a transmission which enables selective adjustment of the rotational period of the cam system. The platform may be of selectively adjustable length, and adjustment of the transmission may enable proportional matching of the rotational period to a quotient of platform length and circumferential speed of the rollers. The cam system may include a cam shaft, a cam, and a roller shaft configured to drive the rollers. The cam shaft may be coupled to drive the cam, wherein gears disposed on the shafts define a plurality of gear drive positions, each position associated with a different cam speed. The transmission may be a manual transmission and may comprise a size selector system configured to selectively engage one of the gears and thereby select one of the gear drive positions based on receiving substrate size. The transmission may include a guide for the size selector system. The gears on one of the shafts may be rotatably associated with a free spinning shaft while the gears on the other shaft are rotably fixed to a fixed gear shaft, and the manual transmission may further include a collar for each rotably associated gear, so that the respective collar is rotatably fixed to the free spinning shaft. The size selector system may fix a selected rotatably associated gear to the respective collar, thereby selectively engaging a selected gear train. In an embodiment a system motor drives the roller shaft which acts as the fixed gear shaft, and the cam shaft acts as the free spinning shaft comprising the collars, and rotably associated gears on the cam shaft engage rotatable fixed gears on the roller shaft. The size selector system may include a key configured to fit into a keyway formed in the collar and an associated free-spinning gear of a selected gear train when a respective size is selected.

Also according to the invention, there is disclosed a method for disposing of animal waste. In another series of embodiments the method includes providing a segment of first sheet material comprising a fluid absorbent region formed on a first fluid impermeable substrate and placing the segment on a platform. A segment of second sheet material comprising a second fluid impermeable substrate is also provided. Animal waste is received in the fluid absorbent region of the first sheet material and outer edge regions of the first sheet material are sealed to outer edge regions of the second sheet material, while not pressing (i) a middle region of the first sheet material between the outer edge regions and (ii) a middle region of the second sheet material between the outer edge regions. This encloses and seals the animal waste between the first sheet material and the second sheet material, and within the outer edge regions. The method may further include positioning the segment of first sheet material in a first location where the animal waste is received in the fluid absorbent region of the first sheet material and, after the animal waste is received, moving the first sheet material from the first location to a position where the outer edge region of the first sheet material contacts the outer edge region of the second sheet material. The step of sealing the outer edge regions to one another may include pressing the outer edge region of the first sheet material against the outer edge region of the second sheet material. each first sheet material segment comprises a discrete absorbent pad that constitutes the fluid absorbent region. The method may include sensing the presence of an animal and then an absence of the animal before moving the segment of the first sheet material. A pair of rollers may seal the outer edge regions together. The rollers may also move the first and second sheet materials, e.g., by pulling on the outer edge regions to move the fluid impermeable substrates. In an embodiment the first location is over a platform upon which the first sheet material rests and a sensor determines when to begin moving the first sheet material. A pair of rollers may seal the outer edge regions together under pressure. Adhesive may be located between the outer edge regions, e.g., by pre-positioning adhesive on a surface of the first sheet material outer edge region. The rollers may seal the outer edge regions together between the rollers and a stationary surface or between the rollers and secondary rollers. The method may include removing the segment of first sheet materials from the platform to seal the outer edge regions while providing a new segment of first sheet material on the platform for subsequent use. As the first segment of sheet material is removed from the platform a continuous roll of the first sheet material may supply the new segment of first sheet material. The segment of second sheet material may be moved to seal the outer edge regions while a continuous roll of the second sheet material supplies a new segment of the second sheet material. The enclosed animal waste may be moved to a receiving space. Also, the method may include forming a transverse seal between the first sheet material and the second sheet material transverse to the outer edge regions. The transverse seal may span the outer edge regions to fully encapsulate the animal waste between adjacent transverse seals, and a cam driven mechanism may be used to form the transverse seal. A period of a cam driven mechanism cycle may cause the transverse seal to occur between discrete pads of absorbent material as the fluid impermeable substrates are moved. The method may include selecting one of a plurality of period options for the cam driven mechanism. The location for receiving the animal waste may be over a platform of selectable length upon which the first sheet material rests, with the method including selecting one of a plurality of platform length options, selecting a first sheet material comprising a plurality of discrete absorbent pads each characterized by a length corresponding to the selected length of the platform, and selecting the period option that corresponds to the discrete pad length. A manual transmission may provide the plurality of period options. The cam driven mechanism may be driven by a system source that also drives a pair of rollers that move the sheet materials. The period of the cam driven mechanism may be adjustable with respect to a speed of the rollers.

According to still another series of embodiments, the invention includes a packaging system for receiving pet excrement. The system is useful with an apparatus which positions components of the system to receive and enclose the pet excrement in isolation from the surrounding environment. The apparatus may include a platform having first and second sides along which a component of the system can be movably positioned to receive the pet excrement and carry the pet excrement along the platform. In one embodiment the system includes a first roll of fluid impermeable material of predetermined length and width and a second roll of fluid impermeable material of predetermined length and width.

The first roll of fluid impermeable material has first and second opposing side regions extending along the length of the first material. The width of the first roll, which extends across the first material from an edge of the first side region to an edge of the second side region, is suitable for movement of each side region along a different one of the first and second sides of the platform. The second roll of fluid impermeable material has third and fourth opposing side regions extending along the length of the second roll. The width of the second roll, which extends across the second material from an edge of the third side region to an edge of the fourth side region, is suitable to effect placement of the first side region along a portion of the first material against the third side region along a portion of the second material and placement of the second side region along the portion of the second material against the fourth side region along the portion of the second material. When the first side region and the third side region are pressed against one another a seal is created between the first and third side regions. When the second side region and the fourth side region are pressed against one another a seal is created between the second and fourth side regions. The first material comprises a series of spaced apart middle regions each extending between or to the first and second opposing side regions. The second material comprises a series of spaced apart middle regions each extending between or to the third and fourth opposing side regions and positioned for contact with a middle region of the first material. When each middle region in the first series is pressed against a middle region in the second series a transverse seal is created between one middle region in the first series and one middle region in the second series such that after two such transverse seals are created, the first and second materials are bonded to one another to form a sealed region between the two middle regions suitable for containing the pet excrement and which provides a seal which physically isolates pet excrement contained in the sealed region from the surrounding environment.

### BRIEF DESCRIPTION OF THE DRAWINGS

The invention is explained in the following description in view of the drawings, wherein:

FIG. 1 provides a side elevation view of an animal waste disposal system according to the invention;

FIG. 2A is a partial perspective view of the system shown in FIG. 1, illustrating components which convey substrate sheets;

FIG. 2B is another partial perspective view of the system of in FIG. 1, shown with receiving substrate material and cover substrate material installed for operation;

FIG. 2C is a plan view showing receiving substrate material and cover substrate material joined and bonded to one another via edge seals to form a package;

FIGS. 3A and 3B are perspective views of the system shown in FIGS. 2A and 2B illustrating dispensers of rolls of receiving and cover substrate material;

FIG. 4A is a perspective view of an unrolled length of the receiving substrate.

FIG. 4B is a view in cross section of the length of the receiving substrate.

FIG. 5A illustrates an example configuration in the animal waste disposal system suitable for movement of receiving and cover substrate material;

FIG. 5B is a partial perspective view of the receiving and cover substrate material in operational positions for use in the animal waste disposal system;

FIG. 6 illustrates a partially processed package formed with receiving and cover substrate material prior to being deposited in a repository;

FIGS. 7A and 7B provide views of edge regions cover substrate material converging with edge regions of receiving substrate material during operation of the animal waste disposal system;

FIGS. 8A and 8B are perspective views of the animal waste disposal system which illustrate a portion of the drive train by which a roller is operably connected;

FIG. 8C is a partial front view of the animal waste disposal system also illustrating a portion of the drive train by which a roller is operably connected;

FIG. 9 is a partial perspective view of the drive train shown in FIG. 8 illustrating an arrangement which introduces a bias force which urges rollers to return to a downward-most position shown in FIG. 8A.

FIGS. 10A and 10B illustrate an adjustment feature of the animal waste disposal system to accommodate multiple sizes of pets;

FIG. 11 illustrates occupancy sensor circuitry for controlling operation of the animal waste disposal system based on when an animal is on a platform of the system and when the animal is no longer on the platform;

FIG. 12 is a partial perspective view of animal waste disposal system illustrating components of a cam driven press;

FIGS. 13A and 13B are side views of the cam driven press illustrating alternate positions of a press bar based on cam position;

FIG. 14 is a simplified schematic illustration of a telescoping arrangement between first and second platform sections used to adjust the size of the platform on which an animal stands in the animal waste disposal system;

FIG. 15 is a flow diagram describing operational processes of the animal waste disposal system;

FIG. 16 is a front view of a drive train which powers operation of the animal waste disposal system;

FIG. 17 is a perspective view illustrating components in the drive train shown in FIG. 16;

FIG. 18 illustrates components of a shift mechanism for a transmission operable in the animal waste disposal system;

FIG. 19 is a perspective view which illustrates components of the transmission and shift mechanism referenced in the description of FIG. 18;

FIG. 20 is a partial perspective view which further illustrates components of the transmission and shift mechanism referenced in FIGS. 18 and 19;

FIGS. 21A-21D illustrate a series of shift positions for engaging the transmission of the animal waste disposal system;

FIG. 22A is an elevation view of the transmission of the animal waste disposal system illustrating displacement of key collars in a first direction;

FIG. 22B is another perspective view of the transmission of the animal waste disposal system illustrating displacement of key collars in the first direction.

FIG. 22C is another elevation view of the transmission of the animal waste disposal system illustrating displacement of key collars in a second direction;

FIG. 22D is another perspective view of the transmission of the animal waste disposal system illustrating displacement of key collars in the second direction;

FIG. 22E is another elevation view of the transmission of the animal waste disposal system illustrating displacement of a key collar bracket and key collar housings in the first direction;

FIG. 22F is another perspective view of the transmission of the animal waste disposal system illustrating displacement of the key collar bracket and key collar housings in the first direction;

FIG. 22G is another elevation view of the transmission of the animal waste disposal system illustrating displacement of the key collar bracket and key collar housings in a second direction;

FIG. 22H is another perspective view of the transmission of the animal waste disposal system illustrating displacement of the key collar bracket and key collar housings in the second direction; and

FIG. 23 is a partial perspective view of the transmission illustrating components thereof.

### DETAILED DESCRIPTION OF THE INVENTION

Before describing in detail exemplary systems and methods relating to the invention, it should be observed that the present invention resides in a novel and non-obvious combination of elements and method steps. So as not to obscure the disclosure with details that will be readily apparent to those skilled in the art, certain conventional elements and steps have been presented with lesser detail, while the drawings and the specification describe in greater detail other elements and steps pertinent to understanding the invention. Also, the following embodiments are exemplary constructions which do not define limits as to structural arrangements or methods according to the invention. The now described embodiments are exemplary and permissive rather than mandatory and are illustrative rather than exhaustive.

The invention provides a system for receiving animal waste without requiring the caregiver to take any immediate action in a residential environment. To provide the reader with an overall understanding of inventive concepts embodied in the specific designs now illustrated, a brief summary of an exemplary system and associated methods is first provided. In one series of embodiments a disposal system includes a conveying mechanism which dispenses and carries two disposable sheets from separate dispenser units and merges the sheets against one another to enclose the waste. In the illustrated design both of the sheets are provided in separate rolls that are simultaneously unwound from the dispenser units. The first sheet, referred to as a receiving substrate, is multi layered, having an absorptive upper layer for receiving waste and an impermeable under layer. The second sheet, referred to as a cover substrate is impermeable. After waste is placed on the receiving substrate the cover substrate is placed over the receiving substrate to cover the waste and portions of the two sheets are joined to provide a hermetically sealed bag or package containing the waste. The sealed bag is severable from the other portions of the rolls of sheets.

Prior to forming the seal, regions of the cover substrate and regions of the receiving substrate which collectively form edge regions of the bag are positioned in alignment with one another. The aligned regions of the two substrates are then bonded to one another. Numerous types of bonds may be created to form the sealed bag. These include melting of substrate material to join the substrates together along the edge regions. As more fully described for an illustrated embodiment, with the substrates provided as sheets on rolls, surfaces along the side edges of one or both of the rolled substrates may be provided with an adhesive material or other bonding agent. The surfaces along the side edges are then pressed together with the adhesive material at the interface to bond the surfaces of the two substrates together along the side edges. The bonded surfaces along the side edges of the pair of substrates form a pair of sealed edge regions.

In one series of embodiments the bags are formed in a generally rectangular shape from the two rolls of substrates with each sheet of substrate material having parallel side edges and substantially the same width. When the side edges of the different sheets are aligned and joined to one another they result in a first pair of parallel edges of the sealed bag. A second pair of parallel edges of the bag results after cutting or otherwise severing portions of the two substrates in regions where surfaces of the two substrates are bonded to one another. The process of cutting or otherwise severing occurs through the bonded regions thereby dividing the bonded regions along lines which are transverse to the first pair of parallel side edges. This results in the sealed bag having a second pair of side edges perpendicular to the first pair of side edges, thereby providing a substantially rectangular shape. In these embodiments, the side edges in the second pair are only severed from other portions of the bonded regions of the substrates after the corresponding surface regions of the substrates have been sealed together to form the bonded regions. In fact, recognizing that the bags can be created in a sequence, each time one of the edges in the second pair of edges is created by severing a bonded region for a first bag, another edge is created in the same bonded region, which is one of the second parallel edges in the next bag in the sequence. That is, in the process of severing the bonded region along a line transverse to the first pair of parallel sides there are created: (1) the second edge in the second pair of edges of a first bag and (2) the first edge in the second pair of edges of a next bag in the sequence. For each sealed bag, the combination of two pairs of parallel sides results in the generally rectangular bag shape.

In accord with at least the one series of embodiments in which the rectangular bags are formed, the receiving and packaging of waste can be performed with an electro-mechanical system that receives the waste onto a portion of the receiving substrate while that receiving portion is moveably positioned over a region of a platform where waste is deposited. Once the waste is placed on a portion of the receiving substrate, the system conveys that same portion of the receiving substrate away from the area over the platform where waste is deposited while other segments of the receiving substrate are unrolled from the dispenser units. Thus the system replenishes by conveying an unused portion of the receiving substrate to the position in the area over the platform where waste is deposited each time a used portion of the receiving substrate moves away from that area. As the used portion of the receiving substrate moves away from the area over the platform where waste is deposited, a portion of the cover substrate is positioned over the received waste and, using both the portion of the cover substrate and the used portion of the receiving substrate on which the waste is deposited, the waste is packaged into a sealed bag. While individual segments of the receiving substrate are each sequentially moved past the platform after receiving waste, the system merges a segment of the cover substrate with an individual used segment of the receiving substrate for bonding thereto in order to form the sealed bag. When regions of the cover substrate or regions of the receiving substrate which become edge regions of the bag are coated with an adhesive, the system seals the regions together. The sealing is effected with application of pressure applied through rolling members as the merged sheets are conveyed away from the region of the platform where waste is deposited. More specifically, the parallel side edges of one substrate are each pressed against a different one of the parallel side edge of the other substrate to create the seals while portions of the substrates between the side edges are not pressed together. That is, portions of the resulting bag between the side edges, in which the waste resides, are not pressed by the rolling members.

When edges of different sheets of substrates are aligned and joined to one another they result in a first pair of parallel sides of the bag. As the segment of the receiving substrate is conveyed along the platform, the segment of the cover substrate merges with it and a seal is created which bonds the two together to form the bag. Additional edge seals are formed to define a seal completely around the bag. The electromechanical system includes a number of advantageous features, several of which are now described in summary fashion.

An exemplary animal waste disposal system 10 according to the invention is more fully described. The system receives pet waste on a substrate sheet, covers the waste with another substrate sheet and provides seals along edges of the sheets to enclose the waste and contain any associated odors. The sealed waste is moved along a path to a repository for disposal at the caregiver's convenience. As noted for one embodiment, the system provides a waste package of substantially rectangular shape, having seals along each of four sides, but other geometries are easily created and the invention is not so limited. The system can be configured to accommodate pets of different sizes and provide waste packages of different sizes.

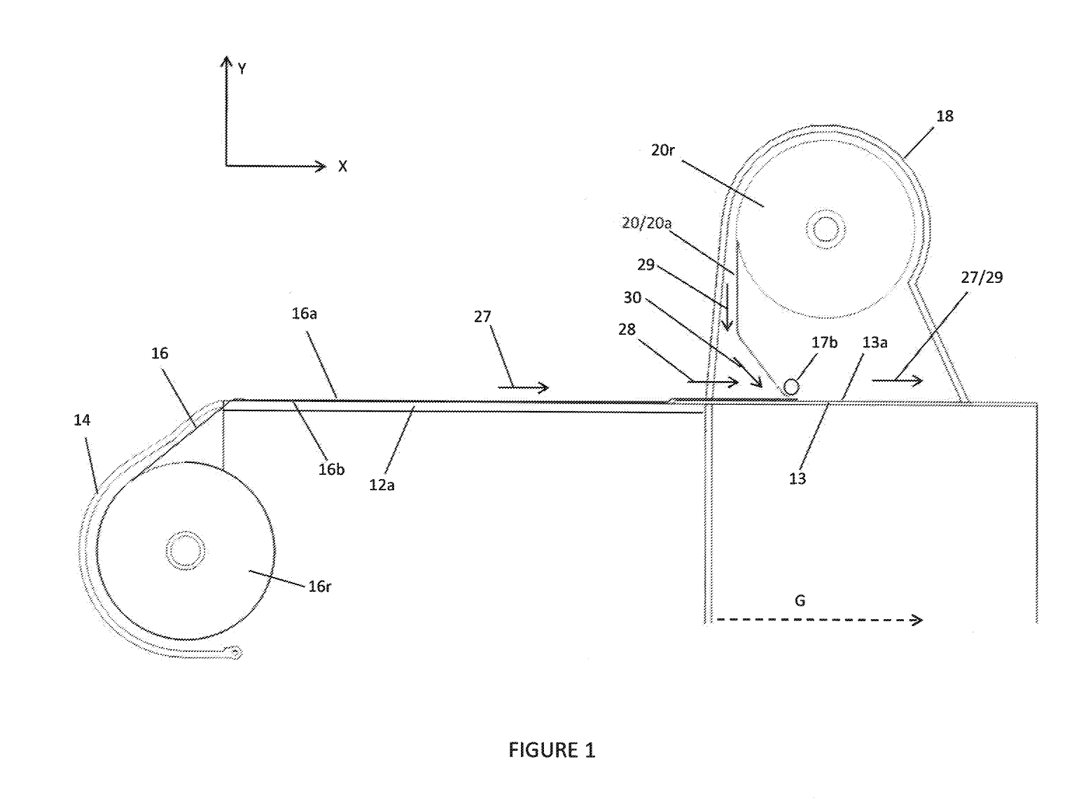

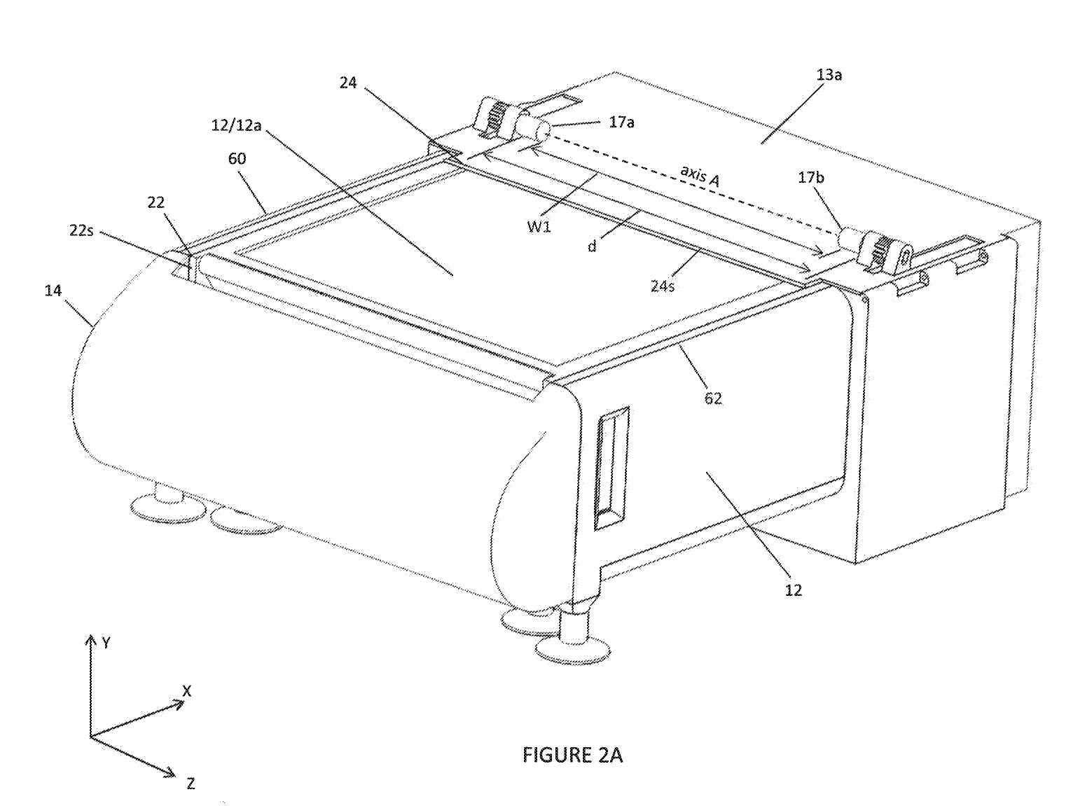

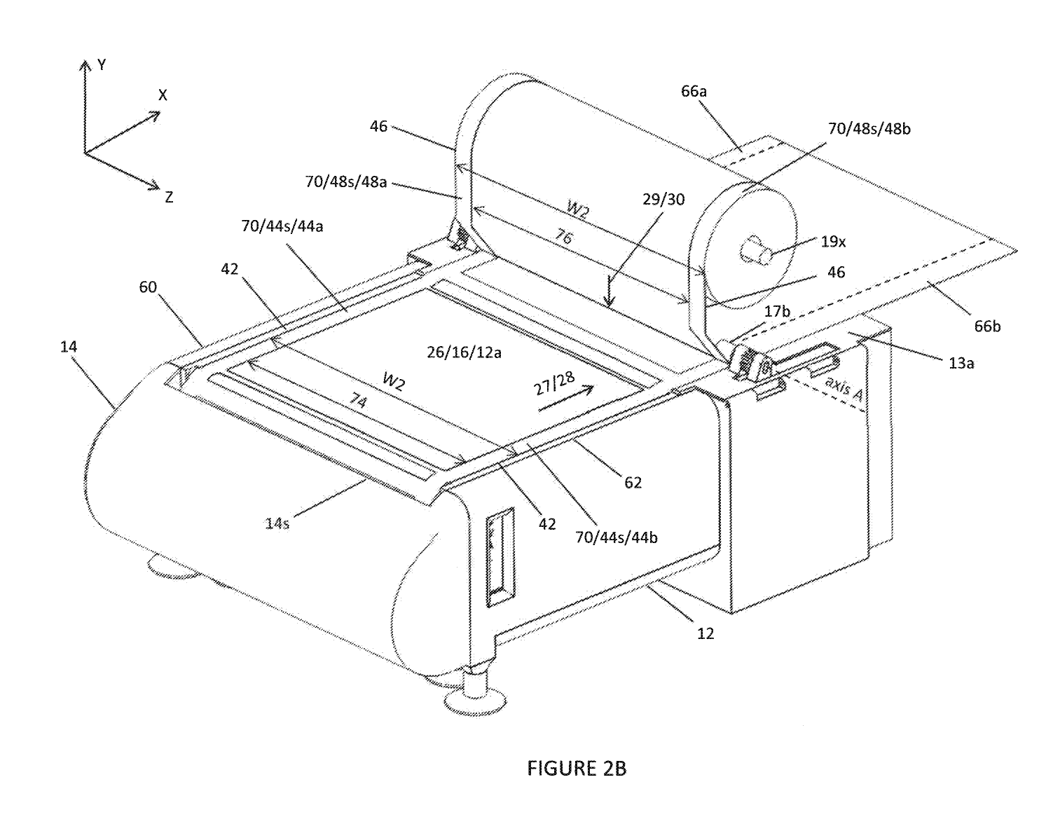

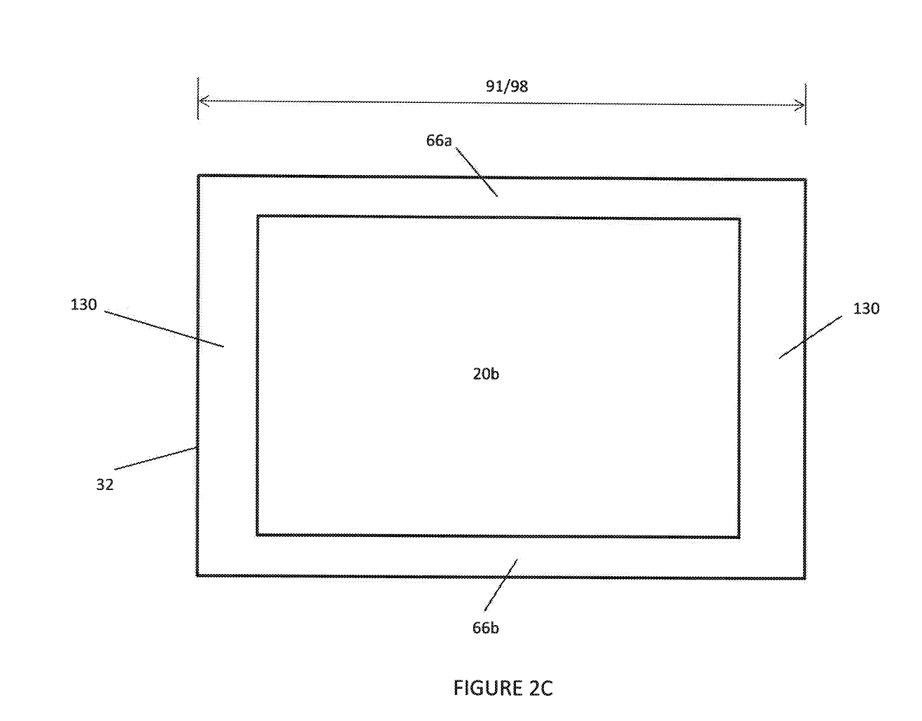

FIG. 1 provides a side view of the animal waste disposal system 10 while FIG. 2A is a partial perspective view of the system 10, shown without disposable sheets of substrate material installed for operation in order to illustrate an arrangement of components which convey the substrate sheets. FIG. 2B is a partial perspective view of the system 10 shown with disposable sheets of substrate material installed for operation of the system 10. For purposes of clarity the views of FIGS. 1 and 2 are shown in a conventional x, y, z Cartesian coordinate system. The view of FIG. 1 is taken along an x-y plane as indicated with x and y axes. A set of x, y, z axes is shown in the perspective views of FIGS. 2A and 2B. For purposes of illustrating orientations and operation of the system 10, the x-z plane is understood to be parallel with a horizontal ground plane, G. Major surfaces of the system 10, including a platform 12 and a press plate 13, have a horizontal orientation (i.e., parallel with the x-z plane) above the ground plane, G.

The platform 12 has a flat upper surface 12a generally rectangular in shape and positioned in a horizontal orientation. The surface 12a is suitable for a pet, e.g., a dog, to stand on. The platform 12 includes a press plate 13, also having a flat upper surface 13a positioned in a horizontal orientation. Two powered drive rollers 17a and 17b are positioned to press against the upper surface 13a of the press plate 13. The rollers are each rotatable about a roller axis, A, which extends in a direction parallel to the z-axis.

The system includes a first sheet dispenser 14 which contains a receiving substrate 16 in the form of a moisture absorbent sheet, and a second sheet dispenser 18 which contains a cover substrate 20. With the platform 12 having an exemplary rectangular shape and pairs of opposing sides, the platform includes a first pair of opposing edges 22, 24 which extend in a direction along the z-axis. The receiving substrate 16 is loaded in the dispenser 14 in the form of a roll 16r, an outer end of which is fed through a slit 14s of the dispenser and then extended along the surface 12a and further in order to pass under the rollers 17a, 17b. The major axis of the roll 16r is oriented in a direction parallel to the z-axis, and the roll 16r is located adjacent the upstream edge 22 of the platform 12. The receiving substrate 16 is loaded in the dispenser 14 in the form of a roll 16r.

An upstream edge 22 of the platform upper surface 12a is positioned along a side 22s of the platform 12. A downstream edge 24 of the platform upper surface 12a is positioned along a side 24s of the platform 12. The upstream edge 22 and the side 22s are most distant from the rollers 17a, 17b while the downstream edge 24 and the side 24s of the platform 12 are most proximate the rollers 17a, 17b. The first dispenser 14 is shown positioned along the side 22s of the platform 12, below the upstream edge 22 of the platform surface 12a. The dispenser 14 may be otherwise positioned with respect to the upstream edge 22 (e.g., under the platform 12), so long as the receiving substrate 16 can be extended from the dispenser 14, over a substantial part of the platform surface 12a (e.g., in the x direction) and toward the downstream platform edge 24.

During operation of the system 10 portions of the substrate 16 are sequentially unrolled from the dispenser 14 on an as-needed basis to move across the platform 12. These unrolled portions are positioned on the platform surface 12a to receive waste, then continue movement across the platform, in the x direction, and pass between each roller 17a, 17b and the plate surface 13a. The rollers 17a, 17b, being spaced apart from one another, define an outside roller spacing width, W₁, sufficient to allow waste deposited on the receiving substrate to pass between the rollers while surfaces adjoining the edges of the unrolled substrate pass under the rollers. See FIG. 2. With portions of the substrate 16 unrolled and positioned both over the platform 12 and under the rollers 17a, 17b, an upper exposed surface 16a of each portion of the receiving substrate 16 that is sequentially positioned over the platform 12 is a receiving region 26 on which an animal, while positioned over the platform 12, provides waste. A bottom surface 16b of the substrate 16, e.g., formed of moisture impermeable material, contacts and slides over the platform upper surface 12a.

The second sheet dispenser 18 is positioned above the plane in which the rollers 17a, 17b reside to feed the cover substrate 20 between each of the rollers 17a, 17b and the plate surface 13a. The cover substrate has first and second opposing sides 20a and 20b. During movement along the path 29 the side 20a comes into contact with the receiving substrate 16 while the side 20b faces away from the receiving substrate. The cover substrate 20 is loaded in the second sheet dispenser 18 in the form of a roll 20r, an outer end of which is then extended to pass under the rollers 17a, 17b. The major axis of the roll 18r is oriented in a direction parallel to the z-axis, and the roll 20r is shown in a position directly above the downstream edge 24 of the platform 12. However, the second dispenser 18 may be positioned anywhere with respect to the rollers so long as the cover substrate can be delivered to pass between the plate 13 and the rollers 17a, 17b.

Portions of the cover substrate 20 are sequentially unrolled from the second dispenser 18 on an as-needed basis to cover waste deposited on the receiving regions 26. These portions of the cover substrate 20 are sequentially positioned over portions of the substrate 16 while they each pass under the rollers 17a, 17b. As the two substrates pass under the rollers, portions of the receiving substrate are each sequentially positioned between a portion of the cover substrate and the press plate 13. While so positioned, the powered drive rollers 17a and 17b press surfaces 44s, 48s along edges 42, 46 of the two substrates 16, 20 against the upper surface 13a of the press plate 13. The combination of the receiving substrate 16 and the cover substrate 20 pass along the press plate while the moisture impermeable bottom surface 16b of the substrate 16 slides along the surface 13a.

The combination of the first dispenser 14, the platform 12, the press plate 13 and the rollers 17a, 17b provide a first path 27 along which the receiving substrate 16 is moved in first directions of travel 28 from the dispenser 14 to and under the rollers. The combination of the second dispenser 18, press plate 13 and rollers 17a, 17b provide a second path 29 along which the cover substrate 20 is moved in second directions of travel 30 from the dispenser 20 to and under the rollers. The paths 27 and 29 converge as the substrates 16, 20 meet while passing between the press plate 13 and the rollers 17a, and 17b.

The rolls 16r, 20r of substrate material 16, 20 each have a width, W₂, measurable along a major axis of each roll as shown in FIG. 2B. The length of sheet material on each roll is arbitrary. Generally the width, W₂, is about the same as the width W₁, or may be slightly larger than W₁ such that the substrates 16, 18 can extend completely across the rollers 17.

During use of the system 10 an animal may position itself over the platform 12 and provide waste on the receiving region 26 of the substrate 16. Afterward, the system moves the receiving substrate 16 along the first path 27 in the directions of travel 28. Simultaneous with movement of the receiving substrate 16, the cover substrate 20 moves along the path 29 in the directions of travel 30. When the paths 27 and 29 converge between the press plate 13 and the rollers 17a, 17b, the receiving substrate 16 and the cover substrate 20 are joined and bonded to one another via edge seals 66a, 66b to form a package 32 shown in FIG. 2C. The package 32 travels away from the rollers 17a, 17b and the press plate 13 to exit the system 10. In the view of FIG. 2C the surface 20b of the substrate 20 is an outer surface of the package 32.

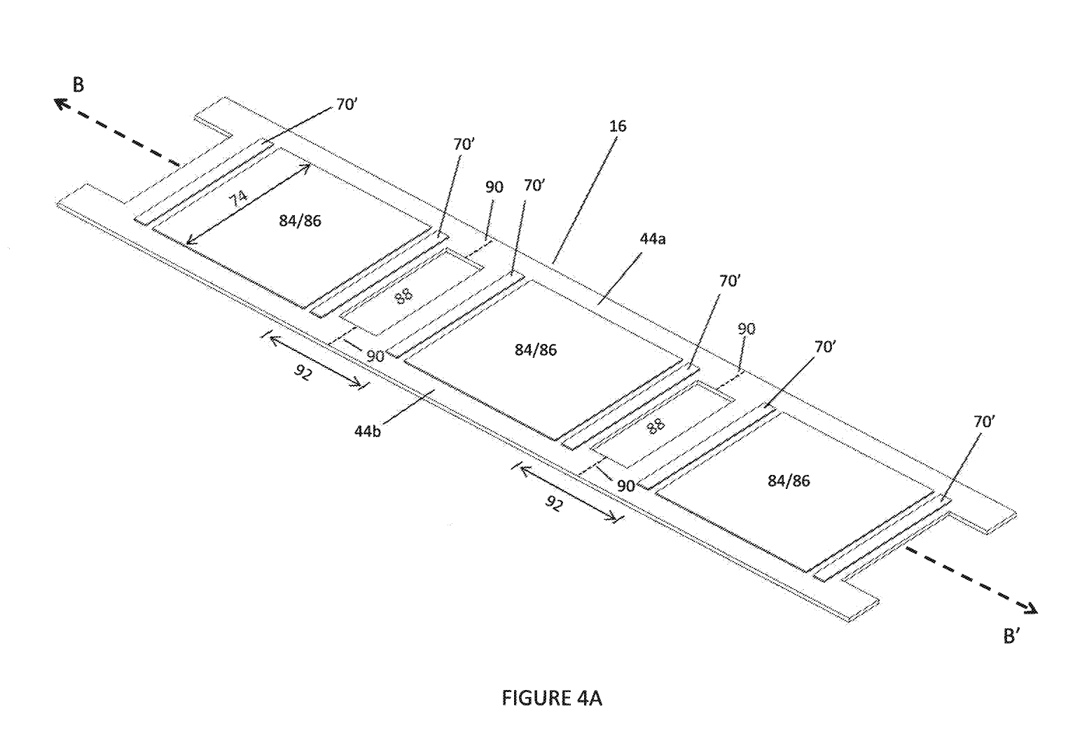

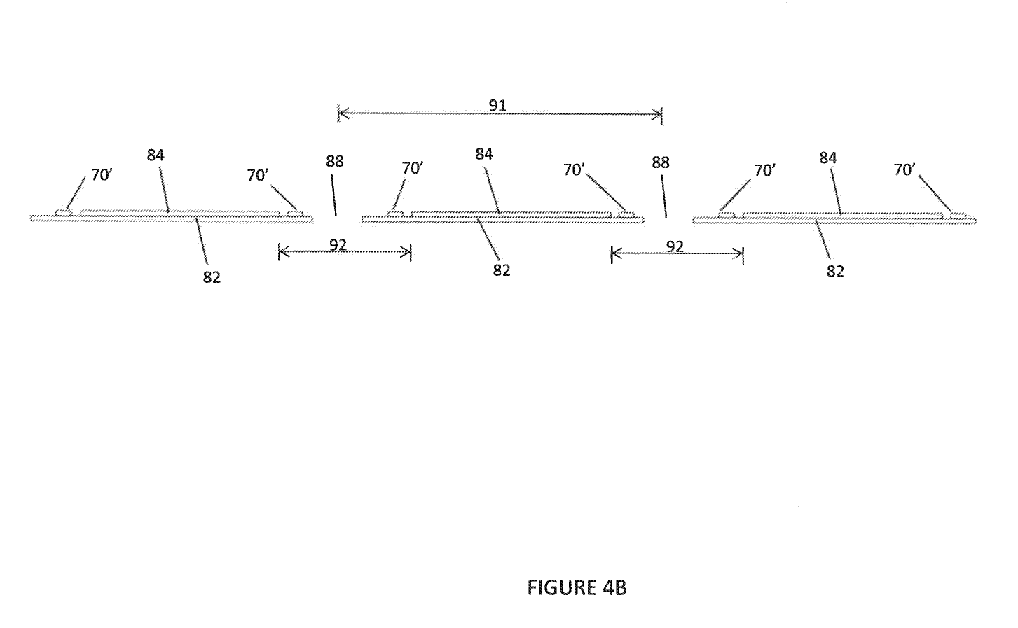

The receiving substrate 16, being in a sheet form, includes first and second opposing edges 42 along its length, i.e., in a direction transverse to the direction along which the described width W₂ of the substrate 16 extends. With reference to FIG. 4, each receiving substrate edge 42 borders an edge region 44a or 44b which extends inward from an edge 42. A portion of each receiving substrate edge region 44a or 44b passes between a different one of the rollers 17a, 17b. Similarly, the cover substrate 20 includes first and second opposing edges 46 along its length, i.e., along the direction transverse to the direction along which the described width W₂ of the substrate 20 extends. Each edge 46 borders a cover substrate edge region 48a or 48b which extends inward from an edge 46. A portion of each cover substrate edge region 48a, 48b also passes between a different one of the rollers 17a, 17b.

The platform 12 includes a second pair of opposing side edges 60, 62 which each extend in a direction along the x-axis. See, again, FIG. 2. During operation of the system 10 the receiving substrate 16, on which waste has been deposited by a pet, is moved along the platform and between the rollers 17a, 17b. Movement is effected by engagement of the powered drive rollers 17a, 17b with each of the receiving substrate edge regions 44a and 44b contacting one of the cover substrate edge regions 48a, 48b so that pairs 44a, 48a and 44b, 48b of contacting edge regions each pass between a different one of the rollers 17a, 17b and the press plate 13. Each of the edge regions 44a, 44b has a surface 44s which contacts a surface 48s of one of the edge regions 48a, 48b.

The receiving substrate edge region 44a travels from the dispenser 14, along the platform side edge 60, to the roller 17a while the cover substrate edge region 48a travels from the dispenser 18 to contact the roller 17a as each passes between the roller 17a and the press plate upper surface 13a. Simultaneously, the receiving substrate edge region 44b travels from the dispenser 14, along the platform side edge 62, to the roller 17b while the cover substrate edge region 48b travels from the dispenser 18 to contact the roller 17b as each passes between the roller 17b and the press plate upper surface 13a.

While portions of the edge regions 44a, 44b of the receiving substrate 16 and portions of the edge regions 48a, 48b of the cover substrate 20 travel between the rollers 17a or 17b and the press plate 13, other portions 74 of the substrate 16 between the edge regions 44a and 44b, including the receiving region 26 on which waste has been deposited by a pet, move along the platform and then between and past the rollers 17a, 17b. Also while portions of the substrate edge regions 44a, 44b, 48a, 48b move under the rollers, portions 76 of the cover substrate 20 between the edge regions 48a, 48b become positioned over receiving regions 26 of the substrate 16 to provide a protective cover about waste left thereon. The receiving region 26 of the receiving substrate 16 and the portions 76 of the cover substrate 20 extend a distance between the edge regions 44a, 48a and 44b, 48b which is commensurate with a distance, d, that the rollers 17a and 17b are spaced apart from one another. As the receiving portion 74 and cover portions 76 move between the rollers, the first dispenser 14 and the second dispenser 18 supply more sheet material from the rolls 16r and 20r to provide another receiving portion 74 and cover portions 76 for a subsequent use over the platform 12. Although the illustrated example employs dispensers 14, 18 which accommodate the substrates 16, 20 provided in rolls, other configurations are contemplated, including dispensers which provide individual pre-cut sheets of a receiving substrate and a cover substrate.

To effect bonding between the substrates 16 and 20, the substrate 16 includes adhesive layer segments 70 and 70′. Each of the contact surfaces 44s includes an edge region adhesive layer segment 70 to effect a seal between each pair of edge regions 44a, 48a and 44b, 48b as the pairs of edge regions are pressed together when passing between one of the rollers and the press plate. In other embodiments, the contact surfaces 48s of the cover substrate may include such adhesive layer segments 70 or the contact surfaces 44s, 48s of both the receiving substrate 16 and the cover substrate 20 may include the adhesive layer segments 70. In still other embodiments the adhesive layer segments 70 may be applied as a separate layer on the contact surfaces 44s and/or 48s to provide an interface between the surfaces 44s, 48s. Bonding with the layer may be effected, for example, during the process of moving the surfaces 44s, 48s between the rollers and the press plate. Generally, when the rollers 17a, 17b press the pairs 44a, 48a and 44b, 48b of edge regions together, an adhesive layer segment 70 bonds each pair of regions along the respective contact surfaces 44s, 48s, thereby sealing the edge regions together. Many other ways of sealing the edge regions will be apparent, these including ultrasonic seals and thermally activated seals.

The rollers 17a, 17b may serve multiple functions. In the example embodiment the rollers converge the edge region pairs 44a, 48a and 44b, 48b and simultaneously effect creation of seals 66a, 66b between edge regions in each pair. See, again, FIG. 2C. Further, by engaging the edge regions 44a, 44b, 48a and 48b, the rollers may effect movement of the receiving substrate 16 and the cover substrate 20. It is to be understood that while these functions are all performed by the rollers 17a and 17b in the embodiment shown, the rollers need not perform all of these functions. For example, the function of pressing the outer edge regions 42, 46 together could be accomplished by another mechanism such as, for example, a pair of flat surfaces which apply pressure to the entire length of each edge region. Movement of the receiving substrate and the cover substrate can be effected with separate drive rollers or with drive gears which engage slots formed in the edge regions for receipt of drive gear teeth. The slots may be formed by the system 10 as the substrates move from the dispensers to the rollers.

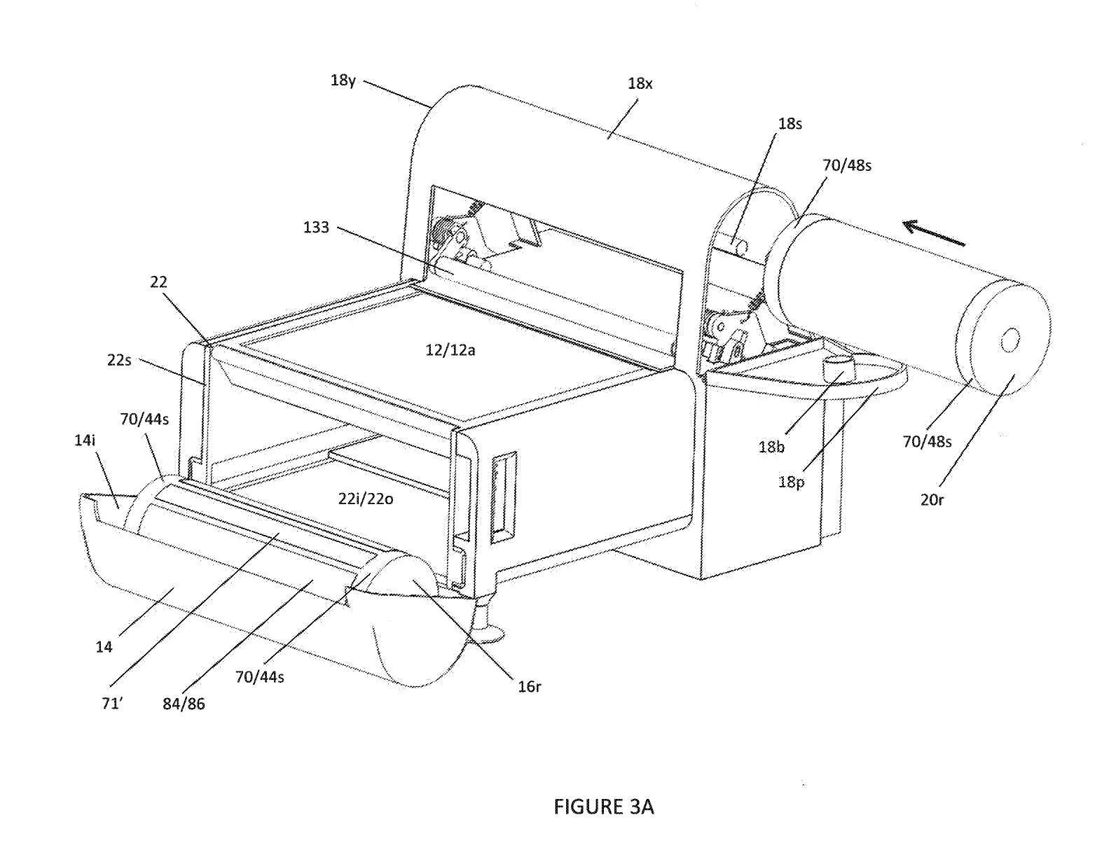

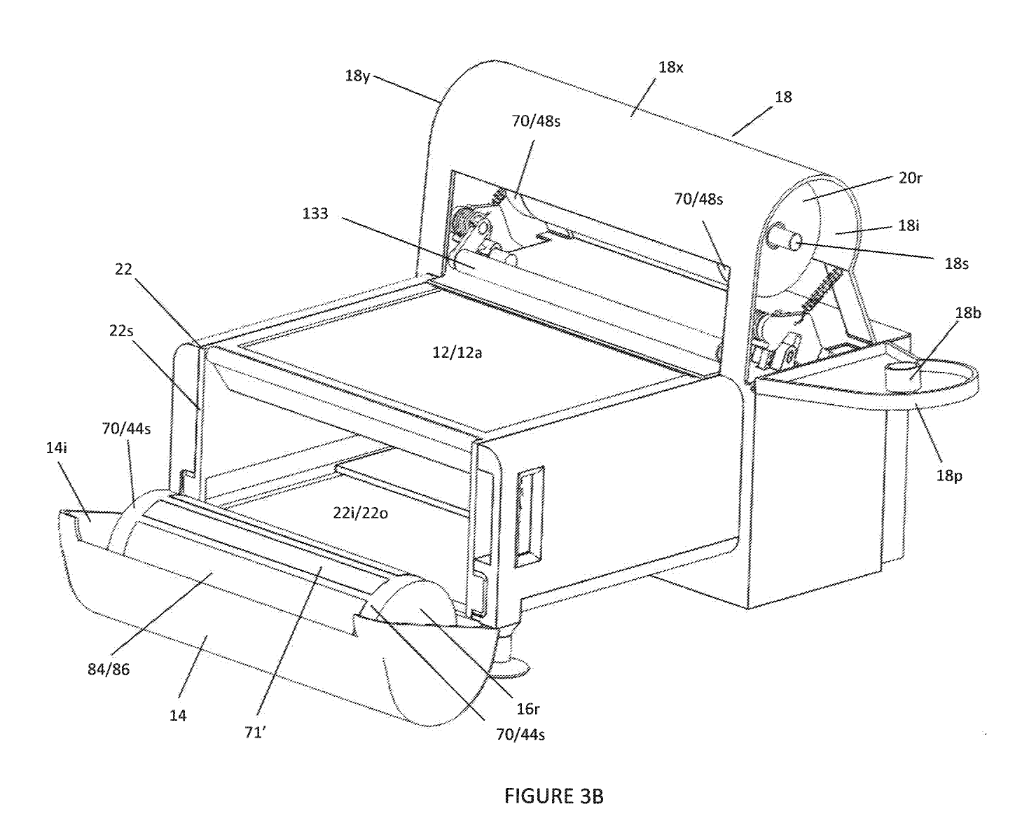

FIG. 3A is a perspective view of the system 10 illustrating an example configuration of the dispensers 14, 18 during operations of loading the dispensers with the substrate rolls 16r and 20r. The dispenser 14 is hinged to the platform 12 along the side 22s. The dispenser can be moved from a closed position, in which it is positioned against the side 22, to an open position as illustrated in FIG. 3. When the dispenser 14 is in the open position the interior 14i of the dispenser 14 is accessible for loading of a new roll 16r therein. Hinged movement of the dispenser 14 to the open position also provides an opening 22o along the side 22s for access to a space 22i interior to the platform, i.e., under the surface 12a. The space 22i is suitable for storage of new rolls 16r, 20r. The roll 16r may simply be seated in the dispenser and unspooled to extend an outer end of the roll 16a through the slit 14s and along the path 27 so that the end regions 44a, 44b of the substrate 16 extend under the rollers 17a, 17b.

With further reference to FIG. 3, the dispenser 18 is positioned above the rollers 17a, 17b (not shown in FIG. 3). The dispenser 18 has a hinged end plate 18p which opens to provide access to an interior space 18i of the dispenser. In FIG. 3A the end plate 18p is shown in an open position with the cover substrate roll 20r positioned for sliding insertion into the interior space 18i of the second dispenser 18. The roll 20r may have a central opening through which a shaft 18s extends to rotatably mount the roll or the roll simply be seated in the dispenser 18 and unspooled to extend an outer end of the roll 20r along the path 28 so that the end regions 48a, 48b of the substrate 20 extend under the rollers 17a, 17b. In the example illustration of FIG. 3 the edge region adhesive layer segments 70 are shown formed on the contact surfaces 48s of the cover substrate 20 as well as on the contact surfaces 44s of the receiving substrate 16.

In other embodiments (not illustrated) the rolls 16r are each wound on a hollow cylindrically shaped spool which extends between end plates. The spool extends along a central axis of the roll 16r or 20r. A removable and reusable spring loaded shaft is inserted through the spool and the end plates. Opposing ends of the dispenser 14 or 20 may be fitted with bearing members which each receive a different end of the shaft to hold the shaft and the spool in a fixed but rotatable position within the dispenser. The shaft may be formed of telescoping members connected with a spring which can be compressed along the central axis of the spool to shorten the length of the shaft. The shaft may be compressed in order to insert the ends of the shaft within the bearing members. Once positioned within the two bearing members the spring may be relaxed so that the shaft assumes a maximum length which constrains the shaft to remain engaged in seats of the bearing members. In other embodiments the shaft spring may become compressed in order to hold the shaft in position. For example, with the dispenser 18 having an exemplary bearing member 18b positioned on the hinged end plate 18p, and another bearing member at an opposing end of the dispenser (not shown), the roll 20r with a telescoping shaft (not shown) extending therethrough can be inserted into the dispenser and secured between the bearing members. When the end plate 18p is closed and locked in the closed position, a modest spring force, which results from a compression of the telescoping shaft, assures securement of the shaft and the roll 20r in a rotational position to dispense the substrate 20.

FIG. 4A is a perspective view of an unrolled length of the receiving substrate 16 and FIG. 4B is a view in cross section of the length shown in FIG. 4A, taken along a central line of symmetry B-B′. The substrate 16 comprises a fluid impermeable backing 82 formed along an underside of the substrate 16b. The backing 82, which corresponds to the aforementioned impermeable under layer, is positionable against the platform surface 12a during operation of the system 10 and serves as an outer impermeable surface along one outer side of the sealed package 32. The receiving substrate 16 also includes a fluid absorbent layer 84, positioned over the backing 82 to receive the waste. When the sealed package is formed the fluid absorbent layer 84 is positioned along an interior surface of the package. In one series of embodiments, the fluid absorbent layer 84 may be provided as a continuous sheet extending the entire width and length of the roll 16a, or may be formed only along the portions 74 of the substrate 16 between the edge regions 44a and 44b, including the receiving regions 26 bordered by the edge regions 44a, 44b.

In other embodiments the fluid absorbent layer 84 may, as shown in FIG. 4, be formed as a series of discrete pads 86 positioned only in the receiving regions 26 and bordered by the edge regions 44a, 44b. Whether the absorbent layer 84 is formed as a continuous sheet or a series of discrete pads 86, it is bonded to the continuous sheet of the fluid impermeable backing 82.

Between the discrete absorbent pads 86 there may be voids or spaces 88 which also extend between the edge regions 44a, 44b. The spaces 88 may be placed in portions of the roll 16r which are not incorporated into the sealed packages 32 after being processed by the system 10.

For each instance in which an animal, while positioned over the platform 12, provides waste on the receiving substrate 16, the system 10 undergoes a cycle of operation which creates a sealed package 32 and unrolls unused segments of the substrates 16, 20 for use in a subsequent cycle. That is, on each different occasion in which a pet provides waste, the cycle of operation includes both creation of a package 32 and provision of fresh segments of the substrates 16, 20 to receive and package waste on a next occasion.

With further reference to FIG. 4, each sealed package 32 is formed from a segment 91 of the receiving substrate 16 which includes a portion of the fluid absorbent layer 84 that has been positioned in a receiving region 26. In the illustrated embodiment the length 98 of the segments 91 is determined in part by selection of a substrate roll. With selection of different substrate rolls 16r, the system 10 can provide a series of different segment lengths 98 to accommodate pets of different sizes. Exemplary segments 91 are shown to extend from within a portion of the substrate in which a space 88 is formed to the next portion of the substrate in which a space 88 is formed. Multiple series of perforations 90 may be formed in the substrate 16 to define and separate individual lengths 98 of segments 91 of the receiving substrate 16 from one another after each bag 32 is formed. Separation may be had by tearing the substrate along a series of perforations. The perforations may be a series of spaced apart cuts which do not fully penetrate through the substrate 16. Alternate methods of separating the bags 32 include manually cutting the formed bags 32 with a pair of scissors or with a mechanical cutting tool built into the animal waste disposal system 10. For the embodiment of FIG. 4 the perforations 90 extend across each of the edge regions 44a, 44b. For embodiments which do not include the space 88 the perforations 90 extend fully across the substrate 16 from the edge 42 of the region 44a to the edge 42 of the region 44b.

For the example embodiment of FIG. 4, each space 88 is formed along a region 92 of the substrate 16 which extends from one discrete absorbent pad 86 to a next discrete absorbent pad 86. Transverse adhesive layer segments 70′ are formed over the backing 82 in the regions 92 on each side of the space 88. By transverse it is meant that the segments 70′ are layers of adhesive that extend between the edges 42 of the receiving substrate 16. They are of a length which at least extends across the middle region 74 of the substrate 16, e.g., from the edge region 44a to the edge region 44b. For each package 32 the system 10 joins portions of the cover substrate to portions of the receiving substrate along two transverse adhesive layer segments 70′ to form a pair of spaced-apart transverse seals 130 along opposing edges of the package 32. The adhesive layer segments 70′ are shown in the figures to extend an arbitrary width between a fluid absorbent layer 84 and an adjacent space 88 which may, for example, range from one to six centimeters. In embodiments of the substrate 16 which do not include the space 88, in lieu of forming two discrete segments 70′, a single, relatively wide transverse adhesive layer segment 70′ may extend between two adjacent fluid absorbent layers 84 with the perforations 90 extending from the edge 42 of the region 44a to the edge 42 of the region 44b.

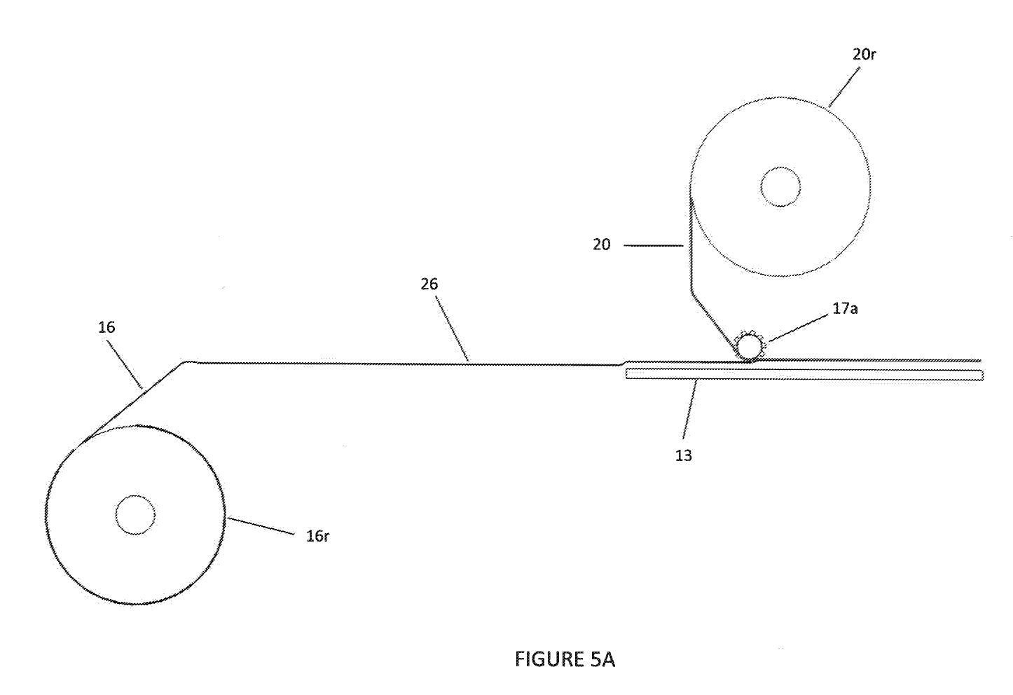

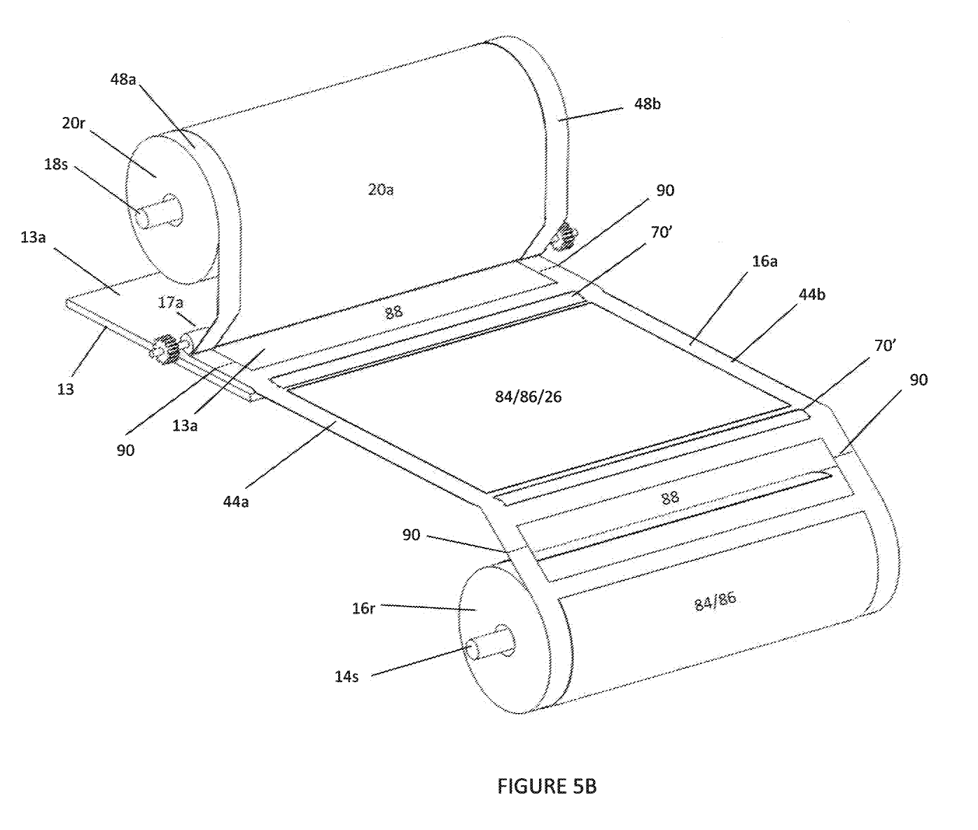

FIG. 5A schematically illustrates a configuration suitable for movement of the receiving and cover substrates in the system 10. FIG. 5B provides a partial perspective view of the substrates 16, 20 in their operational positions for use in the system 10. As can be seen for the edge regions 44a and 48a and one of the rollers 17a, as the substrates 16 and 20 move along the platform surface 12a (see, again, FIG. 1) all of the edge regions 44a, 48a and 44b, 48b pass under the rollers 17a, 17b. Accordingly, members in each pair of edge regions (44a, 48a), (44b, 48b) are pressed together and become sealed to one another.

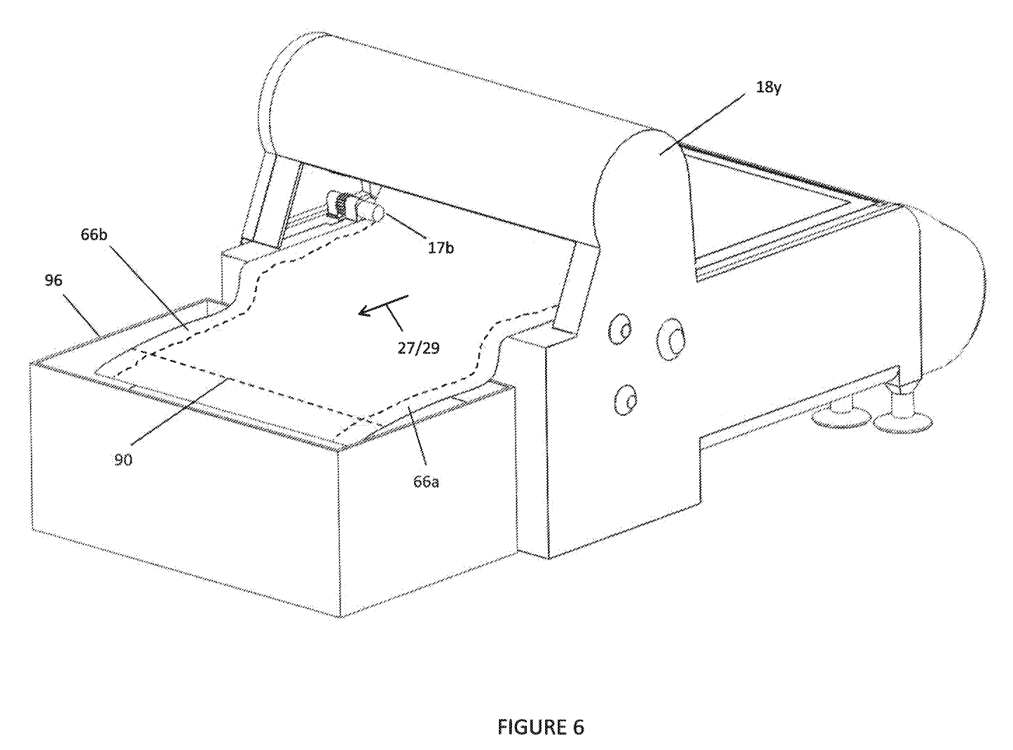

FIG. 6 illustrates a partially processed package 32 after associated edge seals 66a, 66b exit the from beneath the rollers 17a, 17b. The package 32 is shown still attached to other portions of the substrates 16, 20 while movement continues on the converged paths 27/29 to a repository 96, e.g., a cardboard box, in which it is deposited for storage. It will be apparent to those skilled in the art that, in addition to the perforations 90 formed in the receiving substrate, a complementary series of perforations 90 may be formed in the cover substrate which, through the dispensing operation of the system 10, become aligned with perforations 90 on the receiving substrate. Thus, with perforations formed in both the receiving substrate 16 and the cover substrate 20 separation of processed packages 32 may be effected with tearing or cutting methods to detach packages 32 from one another or, more generally, from other portions of the substrates 16, 20 after the packages 32 pass under the rollers or reside in the repository 96. In embodiments not incorporating perforations, the processed packages 32 may be severed from other portions of the receiving substrate 16 and the cover substrate 20 by cutting through the substrates 16, 20. Cutting may be effected by any of numerous methods, including use of a blade and application of heat or radiant energy.

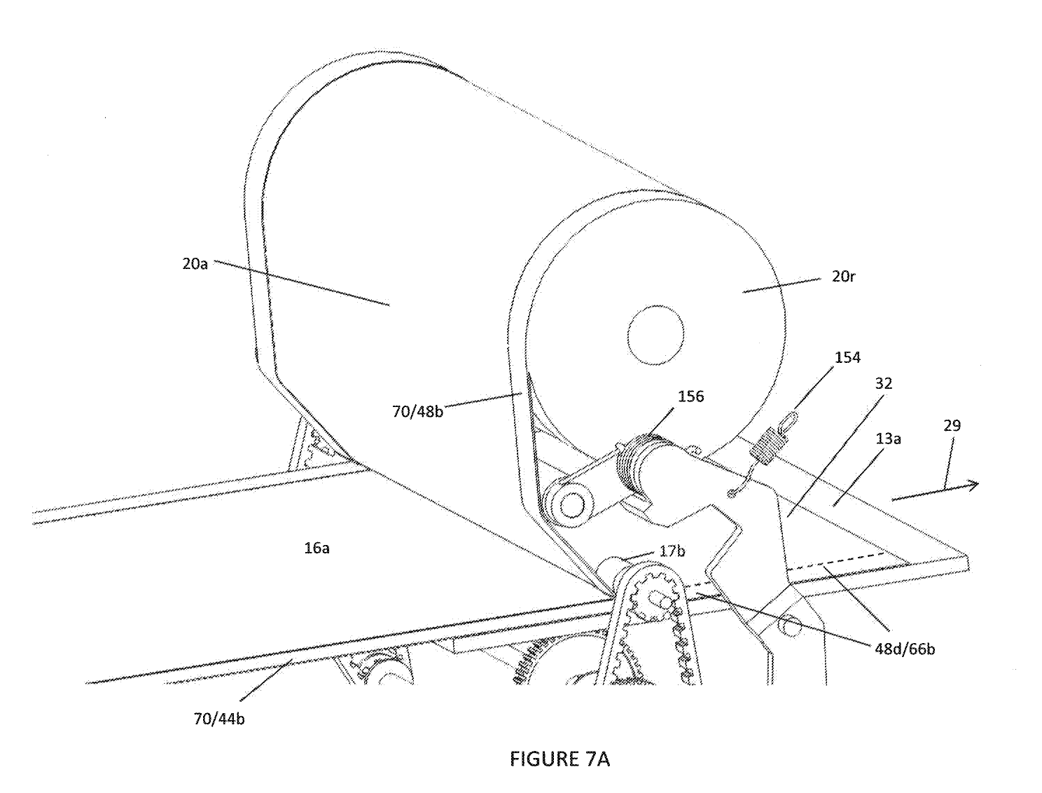

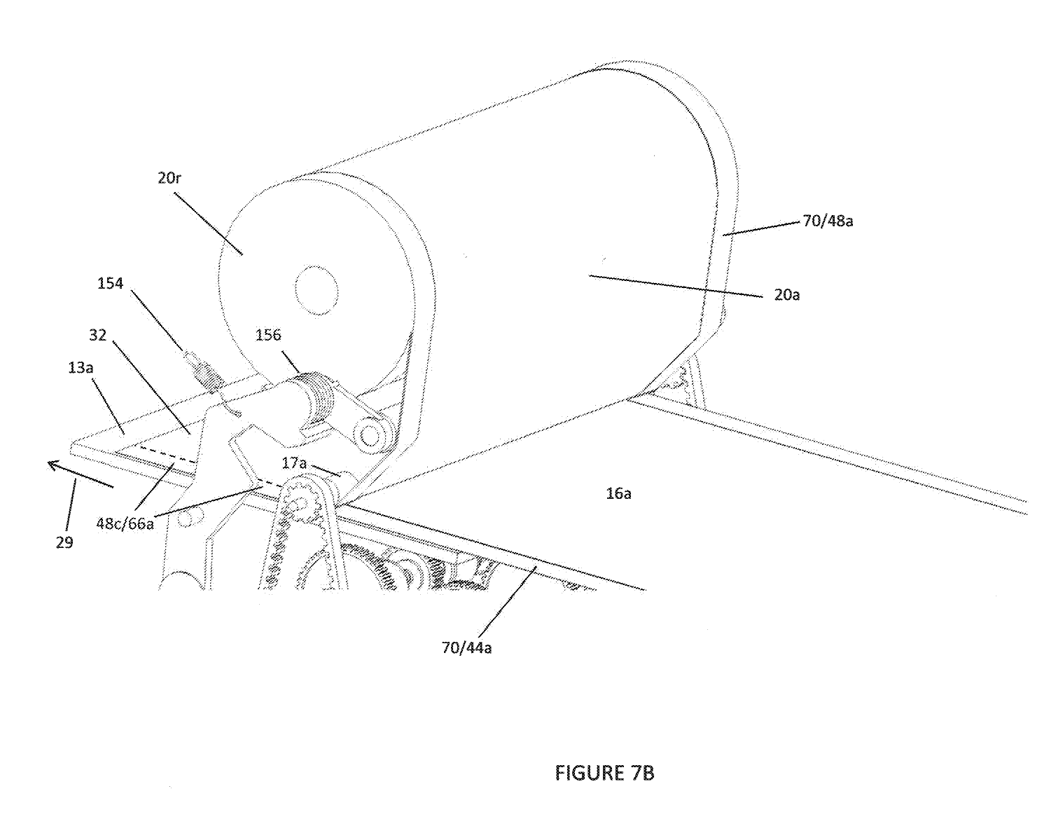

FIGS. 7A and 7B provide views of edge regions 48a and 48b of the cover substrate 20 as each converges with one of the edge regions 44a and 44b of the receiving substrate 16 under one of the rollers 17a, 17b. As these regions of the substrates merge, portions of the surface 20a in the edge regions 48a and 48b of the cover substrate come into contact with portions of the surface 16a in the edge regions 44a and 44b of the receiving substrate 16. Each roller 17a, 17b presses against the press plate 13 to create the seal 66a, 66b with an adhesive layer segment 70 of adhesive at the interface. To facilitate movement of the substrates as they are dispensed from the rolls 16r, 20r, and converged at the rollers 17a, 17b to form a laminate, the outer surfaces of the converged substrates can have different coefficients of friction relative to the surfaces against which they come into contact. For example, the under surface 16b of the receiving substrate (see FIG. 1), may have a low coefficient of friction with respect to the surfaces 12a and 13a along which it slides. On the other hand, relevant portions of the surface 20a of the cover substrate (e.g., the portions 48c and 48d of the surface 20a which are on the edge regions 48, opposite the surfaces 48a and 48b) have a sufficiently high coefficient of friction with respect to the surfaces of the rollers 17a, 17b against which these portions of the surface 20a come into contact thereby providing necessary traction as the rollers drive the cover substrate along the path 29.

With respect to the roller 17a, the relevant surface having a sufficiently high coefficient of friction to assure frictional engagement between the roller and the surface 20b is the portion of the surface 20b, designated surface 48c in FIG. 7A, along the edge region 48a (i.e., the surface 48c is along the side opposite the side of the edge region 48a which is bonded with the edge region 44a to create the seal 66a. With respect to the roller 17b, the relevant surface having a sufficiently high coefficient of friction to assure frictional engagement between the roller and the surface 20b is the portion of the surface 20b, designated surface 48d in FIG. 7B, along the edge region 48b, (i.e., the surface 48d is along the side opposite the side of the edge region 48b which is bonded with the edge region 44b to create the seal 66b.

The surfaces 48c and 48d may be coated with a material which provides suitable properties to assure driving engagement of the surfaces 48c, 48d with the rollers while the surface 16b is a relatively low friction surface. This arrangement enables the substrate 16 to slide along the press plate surface 13a and, consequently, facilitate movement of the converged substrates 16, 20. Thus the rollers 17a, 17b grip the surface 20b of the cover substrate 20 while the bottom surface 16b of the receiving substrate 16 slides easily across the press plate 13. In other embodiments there may be additional rollers against which rollers 17a, 17b press (e.g., in lieu of the press plate 13) to effect the seals 66a, 66b. FIG. 7 also illustrates a mechanism for effecting a transverse seal which is discussed herein.

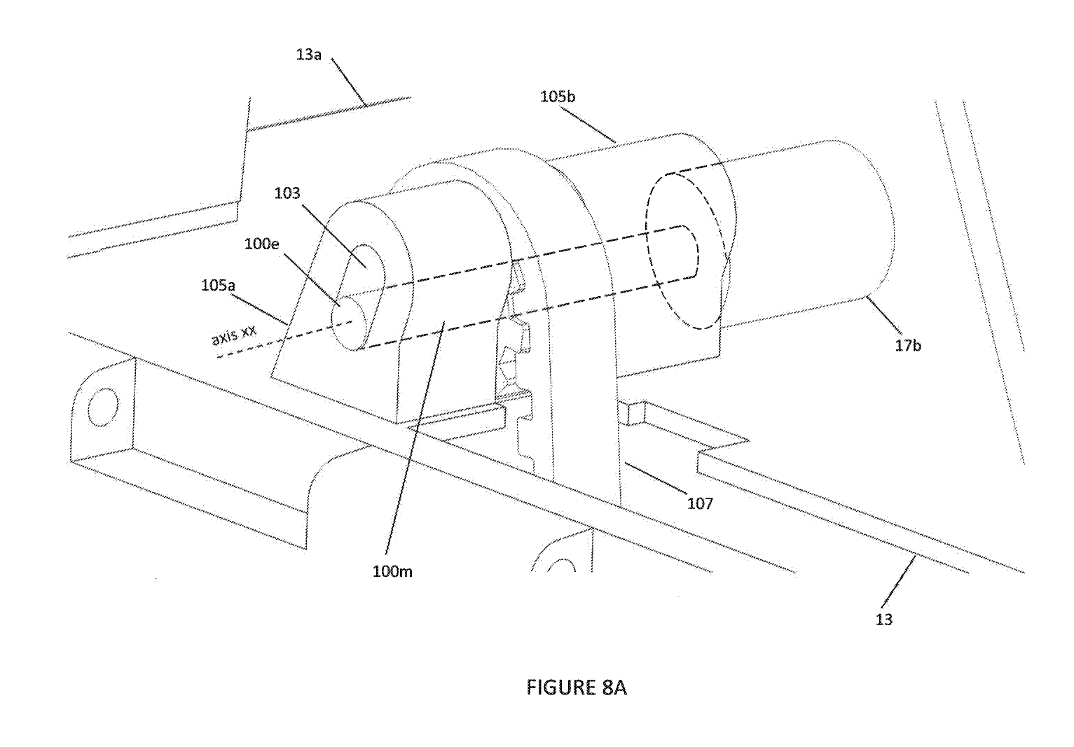

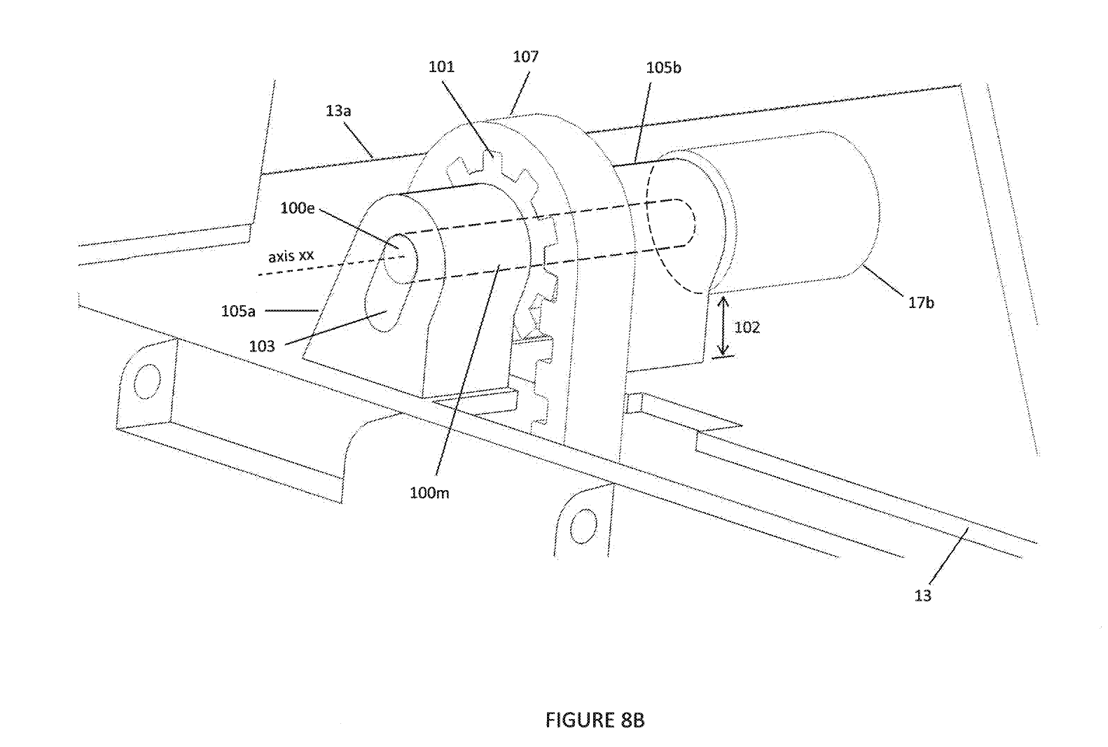

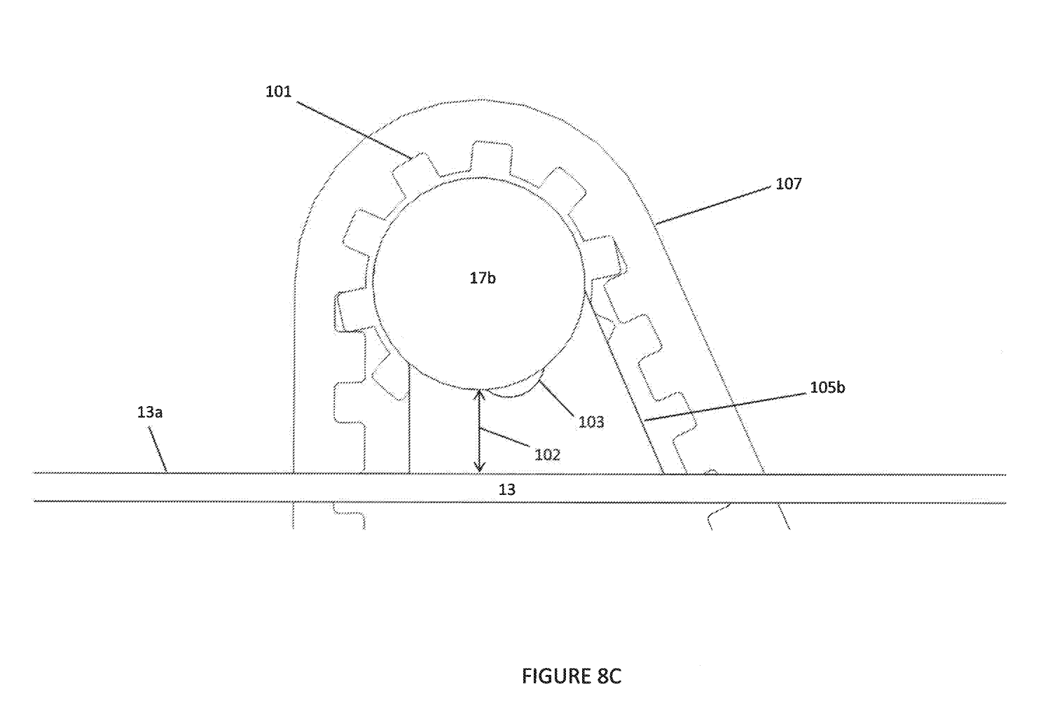

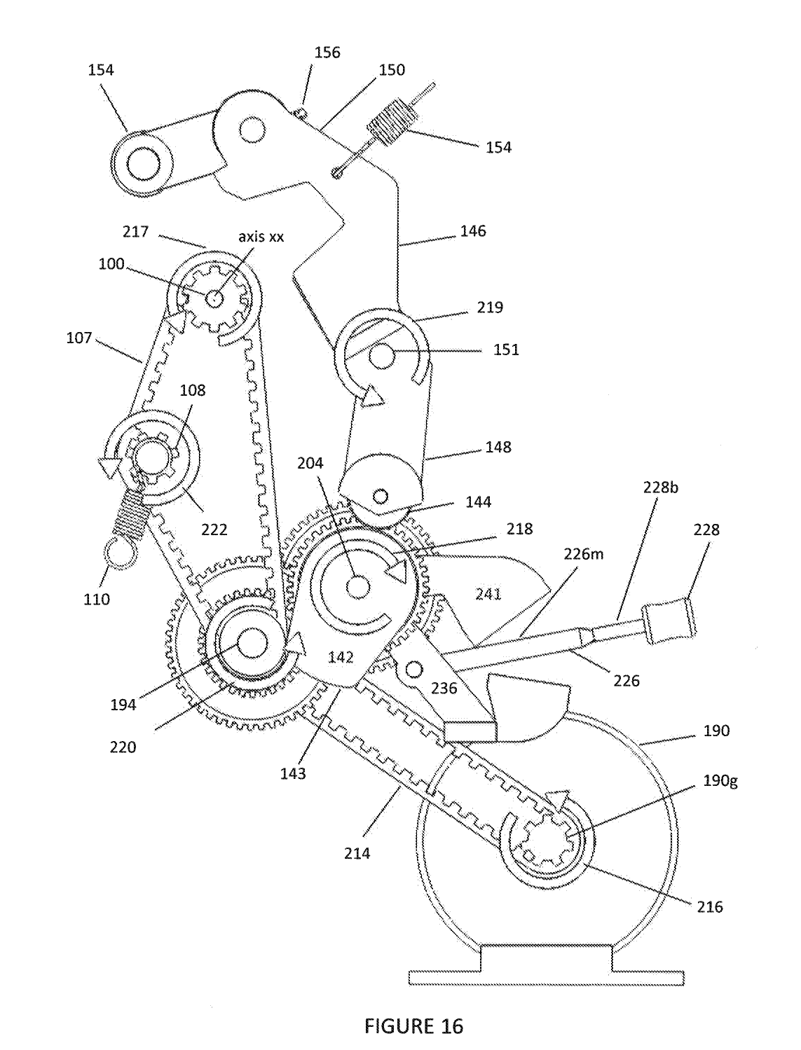

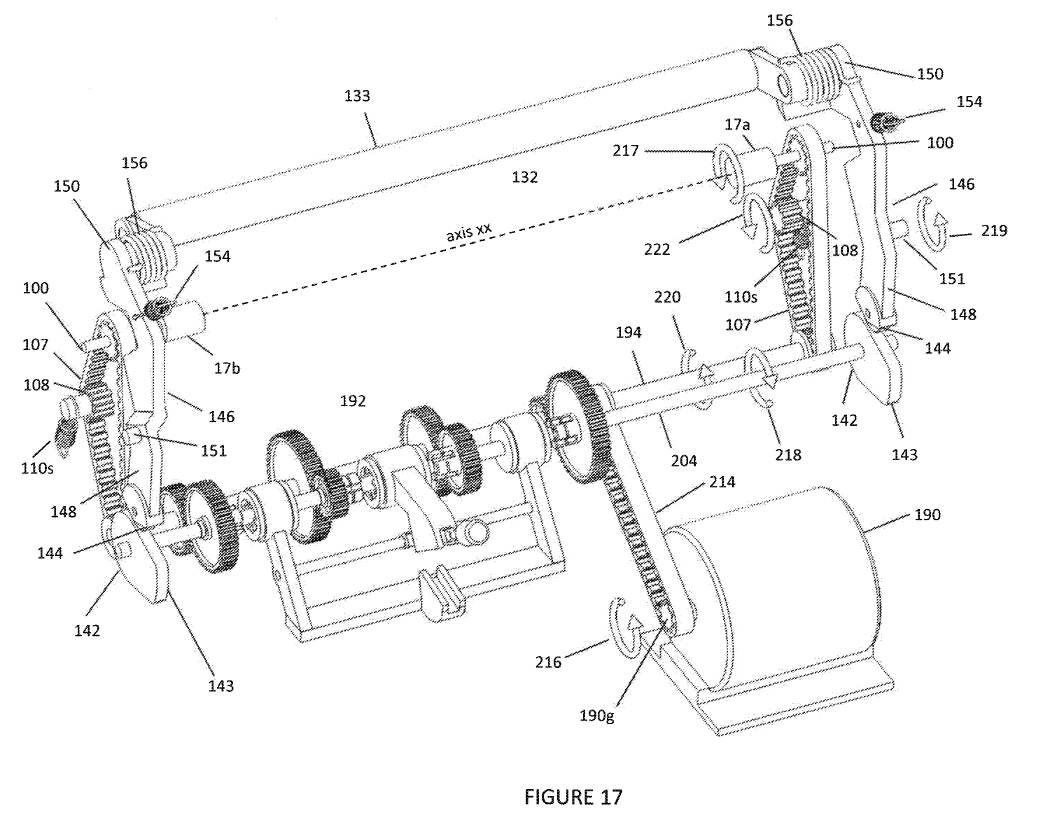

FIGS. 16 and 17 illustrate an electric powered drive train comprising a motor 190 which provides torque for operation of the drive rollers 17a, 17b and necessary force to create seals which completely enclose contents of the bag 32. Portions of the drive train are now described to illustrate several features according to embodiments of the invention. As shown in FIGS. 8A and 8B for the roller 17b, each of the rollers 17a and 17b is mounted on a roller shaft 100 through which each roller is connected to a secondary roller drive gear 101 for rotation. Because the arrangement for the roller 17a is similar to that now described for the roller 17b, the drive arrangement of drive components for the roller 17a is not separately illustrated. Each shaft 100 extends along an axis xx. A feature of the arrangement is an ability to displace the shaft 100 connected to each roller to provide a gap 102 between each roller 17a, 17b and the press plate 13. See FIG. 8C. The gap facilitates feeding the receiving substrate 16 and the cover substrate 20 under the rollers.

In the illustrated example, there is a separate shaft 100 for each roller 17a, 17b. A first pair of mounts 105a, 105b is provided to support the shaft associated with the roller 17a and a second pair of mounts 105a, 105b is provided to support the shaft associated with the roller 17b. Each shaft 100 has first and second opposing ends 100e and a mid portion 100m intermediate each shaft end 100. A first shaft end 100e and a shaft mid portion 100m on each shaft are journaled in different ones of the mounts 105a, 105b in a pair, while the second shaft end 100e (not shown) connects to engage the associated roller for rotation of the roller. The mid portion 100m is indicated with dashed lines in FIGS. 8A and 8b. The mounts 105a, 105b each have an opening 103 through which a shaft end 100e is positioned to receive support from the mount while the shaft 100 rotates.

The openings 103 in each pair of mounts are oblong, being configured to allow vertical displacements of the roller shaft 100. In the illustrated assembly the openings 103 in each pair of mounts 105a, 105b are slots which extend vertically with respect to the horizontal surfaces 12a, 13a. The slots 103 are sized to provide paths along which the ends of the associated shafts can travel upward or downward. FIG. 8A illustrates a shaft end 100e in a downward-most position along one of the slot-shaped openings 103 to receive support from the mount 105a when the shaft rotates. FIG. 8B illustrates the same shaft end 100e in an upward-most position along the same one of the slot-shaped openings 103. When an operator of the system 10 manually applies an upward force to the rollers, this translational freedom of the shafts 100 along the slot shaped openings 103 of the mounts 105a, 105b permits upward movement of each roller 17a, 17b as the associated shaft is displaced in an upward direction, thereby creating the gap 102. Thus an operator may simply lift the rollers 17a or 17b from operational positions against the press plate 13 to lifted positions in which the rollers are spaced away from the surface 13a of the press plate 13 by the gap 102. Providing such a gap which separates the rollers 17a, 17b from the press plate 13 results in a clearance which facilitates feeding of the receiving substrate 16 and the cover substrate 20 under the rollers during loading of the substrates into the system 10 without having to turn the rollers. Subsequent movement of the roller shafts 100 in a downward direction displaces the rollers to remove the gaps 102 and restore the rollers to downward-most positions in which they press against the surface 13a.

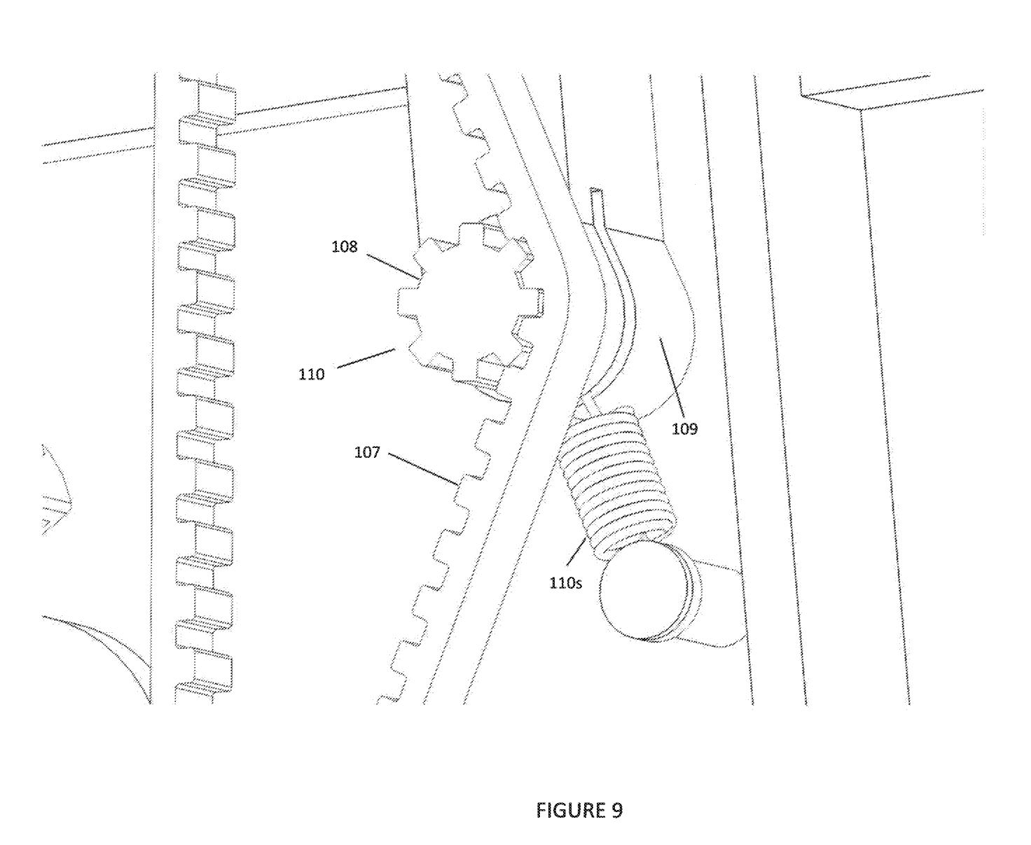

With reference to FIGS. 9, 16 and 17, to facilitate the downward movement and press the rollers 17a, 17b against the surface 13a, the roller shafts 100 are biased with a force e.g., a spring force, which urges the shafts and the rollers to return to the downward-most position shown in FIG. 8A. Generally, the roller shafts 100 may be biased with a variety of mechanical arrangements to transfer a downward force through the rollers 17a, 17b to press the rollers against the surface 13a. In example embodiments each of the secondary roller drive gears 101 is powered by a different roller drive belt 107 to turn one of the rollers 17a, 17b. The belts 107 are tensioned with a tensioner 110 so that the belts apply the bias force to the roller shafts, thereby urging the shaft 100 and roller 17b to the downward positions shown in FIG. 8A. The tensioner 110 comprises a tension gear pulley 108 which can be moved along one direction in a tensioner housing 109. To enable a downward biased movement of each roller shaft 100 within the roller shaft slots 103, the tensioner 110 includes a coil spring 110s positioned to provide a spring force to the tension pulley 108. Force of the spring 110s displaces the tension pulley 108 and transfers a force through the drive belt 107. This, in turn, transfers a bias force to the roller shaft 100 and urges the roller 17a or 17b against the press plate 13. Other tensioning mechanisms can be applied to bias the rollers against the plate 13, including actuators.

In operation, when each roller 17a, 17b is manually moved to the lifted position, e.g., to, load the substrates 16, 20, the associated roller shaft 100 moves within the slot shaped opening 103. This increases belt tension which counters the force of the spring 110 and moves the tension pulley 108. As the roller 17a, 17b is released the counter force of the spring 110s becomes predominant, allowing the tension pulley to resume a position which assures presence of a bias force that urges the shaft 100 and the associated roller in the downward direction along the slotted opening 103. Consequently the roller is applied against the press plate 13 under the bias force of the spring 110s.

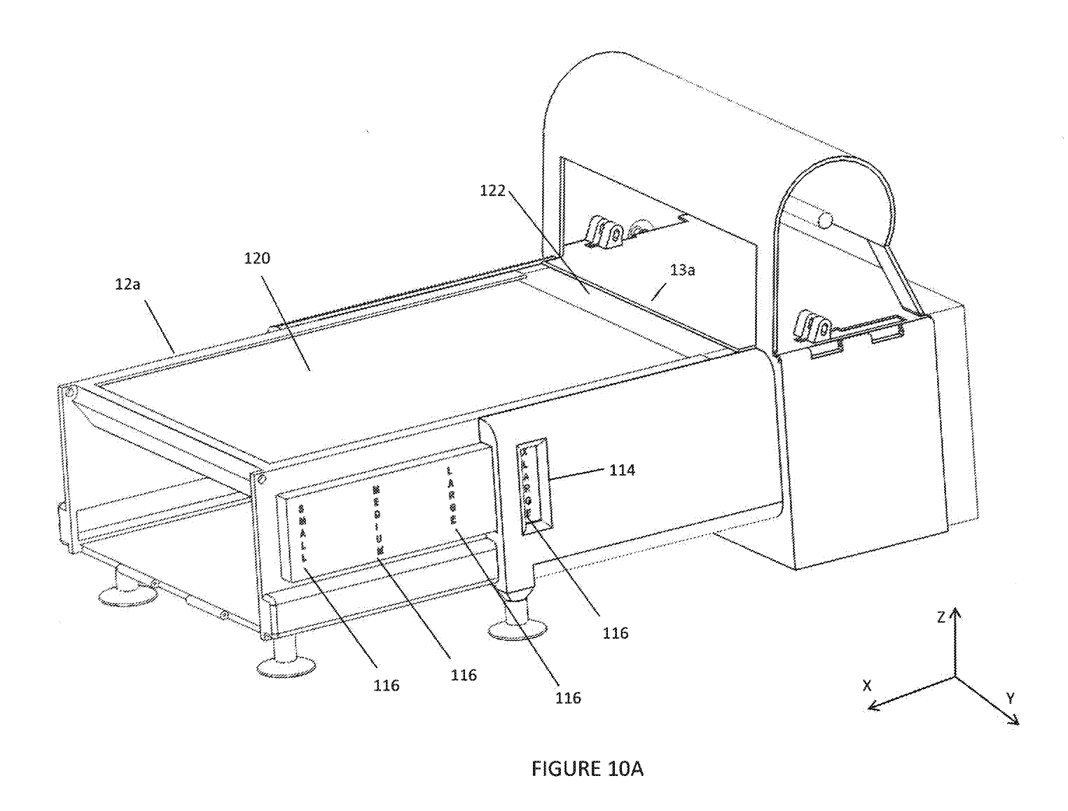

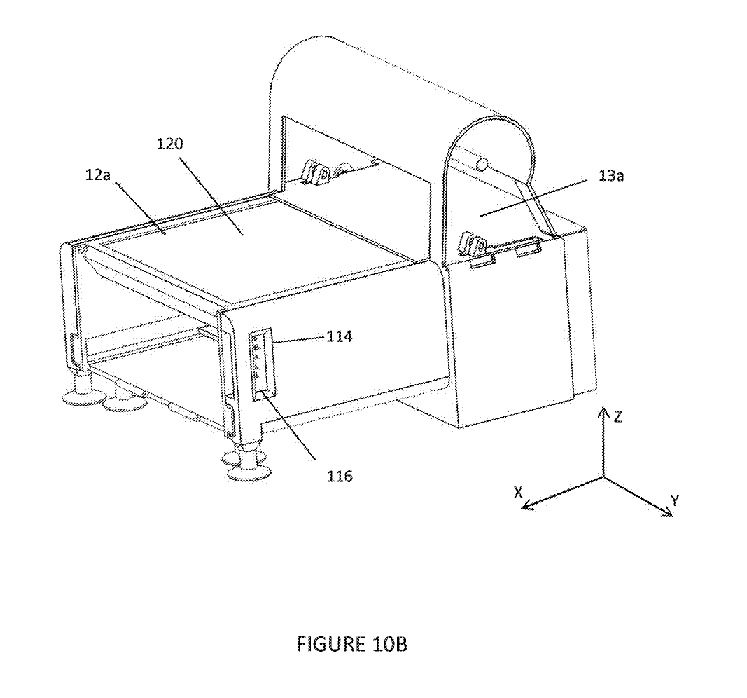

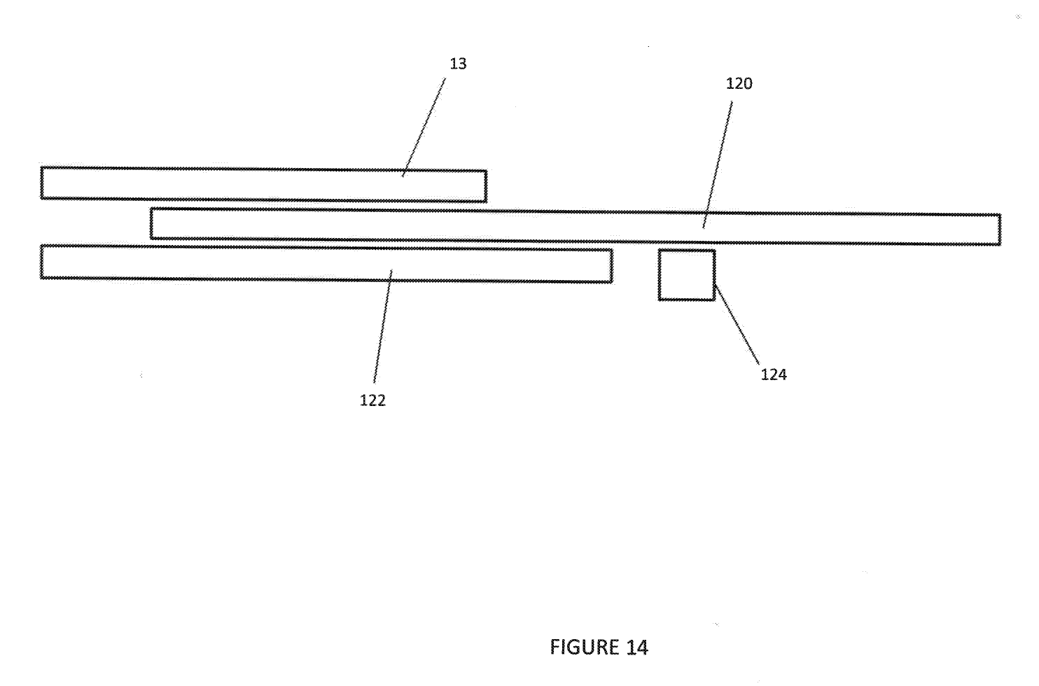

With reference to FIGS. 10A, 10B and 14, the platform 12 is adjustable in length (i.e., along the x direction) to accommodate four different sizes of pets, e.g., dogs for which distance between forward and hind legs varies. Further, with the platform 12 being adjustable, different substrate rolls 16r are provided for each size. For each selected size the receiving areas 26 in a substrate roll can be sized appropriately. In the example embodiment the platform 12 adjusts to small, medium, large, and extra large lengths via a telescoping arrangement between first and second platform sections 120, 122. The position of the second platform section 122 is fixed with respect to the rollers 17a, 17b while the first platform section 120, positioned over the second section 122, is extendable, i.e., such that it can be moved away from the second platform section 122. In FIG. 10A the platform 12 is shown in a fully extended, extra large configuration. In FIG. 10B the platform is shown in a retracted, small configuration. Markings, for selection of platform sizes and to indicate each selected size, are formed in the first platform section 120. A labeled marking on the first section, corresponding to a selected size, becomes visible through an opening 114 in the second platform section for alignment with a mark on the second section. With sliding movement the first platform section can be set in a correct position to provide the platform length corresponding to a desired pet size. The alignment marking 116 indicates that the platform 12 is properly positioned to extend the platform section 120 for use by an extra large pet. Other markings become visible when the first section 120 is moved to other positions.

With the platform length being adjustable, multiple sizes of receiving substrates are available for embodiments of receiving substrates 16 which utilize discrete pads 86 of the fluid absorbent material 84. Different rolls 16r of receiving substrates are provided for each pet size. The rolls for each different pet size are made with the lengths of all of the discrete pads 86 sized according to a selected platform size. When, for example, the platform is adjusted to the small length, the receiving substrate 16 loaded into the dispenser 14 provides discrete pads of a relatively small length. For a given length of the pads 86, the length 98 of the individual segments 91 (see FIG. 4B) corresponds to the size selected for the platform 12. Generally, in embodiments where the receiving substrate 16 includes discrete pads 86, a receiving substrate 16 is provided which has periodic segments 91 of lengths 98 that correspond to a selected size of the platform 12. When the platform size is set to Small, a receiving substrate roll 16r is selected which has periodic segments 91 of lengths 98 suitable for use in the system 10 when the platform 12 is in the Small configuration. Similarly, if the platform size is set to Medium or Large or Extra Large, respectively, a differently sized receiving substrate roll 16r is selected which has periodic segments 91 of lengths 98 suitable for use in the system 10 when the platform 12 is in the Medium or Large or Extra Large configuration. Depending on design of the system 10 and the substrate materials, a universal roll 20r of cover substrate 20 may be used in conjunction with each differently sized receiving substrate roll 16r.

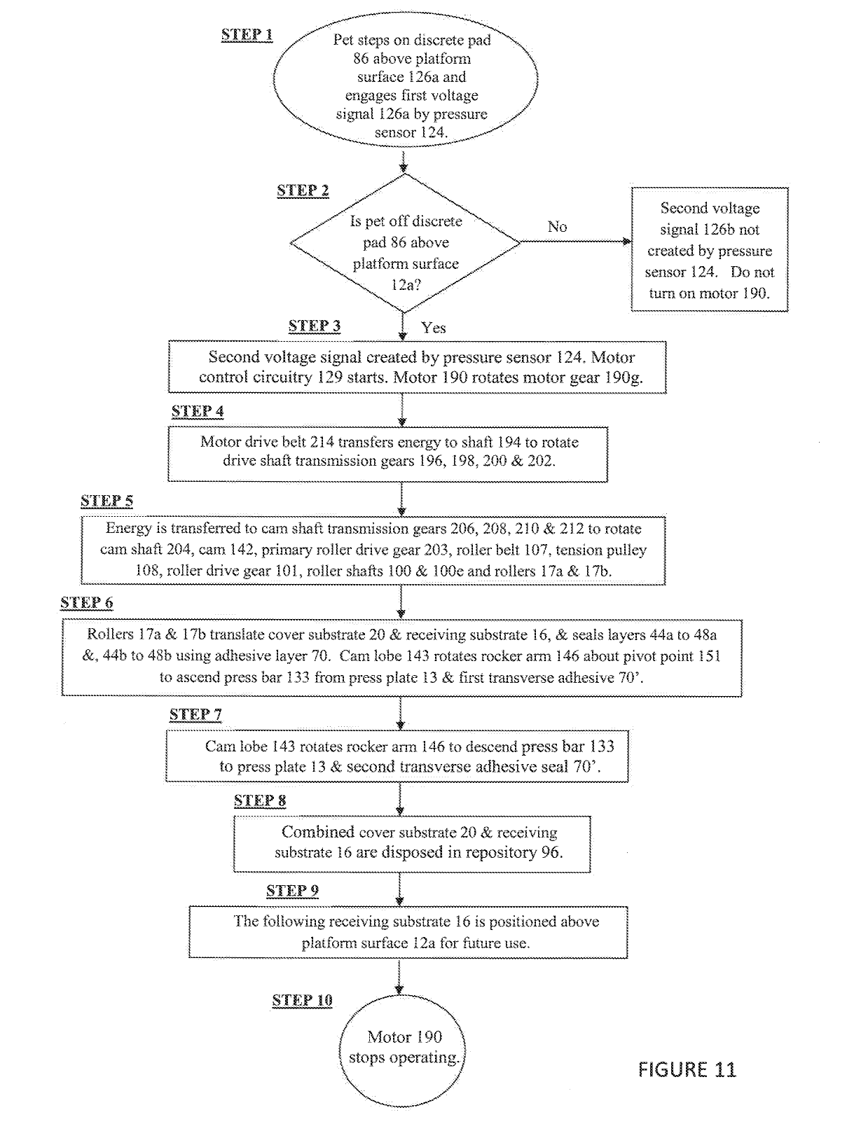

With reference to FIG. 11, the system 10 includes circuitry comprising an occupancy sensor 124 positioned under the platform 12 which renders the system 10 responsive when an animal has been on the platform 12. The occupancy sensor 124, as indicated in the flow chart of FIG. 11, generates a first signal when the animal is on the platform and generates a second signal when the animal is no longer on the platform. In one embodiment, in response to the first signal, circuitry powers up numerous components of the system for operation. Further, in the event that one of the substrate rolls is nearly or completely depleted, an audio alarm (not shown) provides an alert that there is an immediate need to replenish the system with a new substrate roll. Upon generation of the second signal the system 10 begins a cycle of operation in which the receiving region 26, over which an animal was positioned when the first signal was generated, is conveyed past the rollers 17a, 17b to undergo a sealing process which results in formation of a bag 32. The occupancy sensor 124 could be a pressure sensitive (e.g. a piezoelectric sensor, capacitive sensor, electromagnetic sensor, optical sensor or potentiometric sensor) or a light sensor, or another type of sensor which indicates a presence of the pet on the platform. When the system begins a sealing cycle to move and seal deposited animal waste in a bag 32, unused portions of the substrates 16, 20 are moved into positions for subsequent use, i.e., the next time a pet is positioned on the platform.

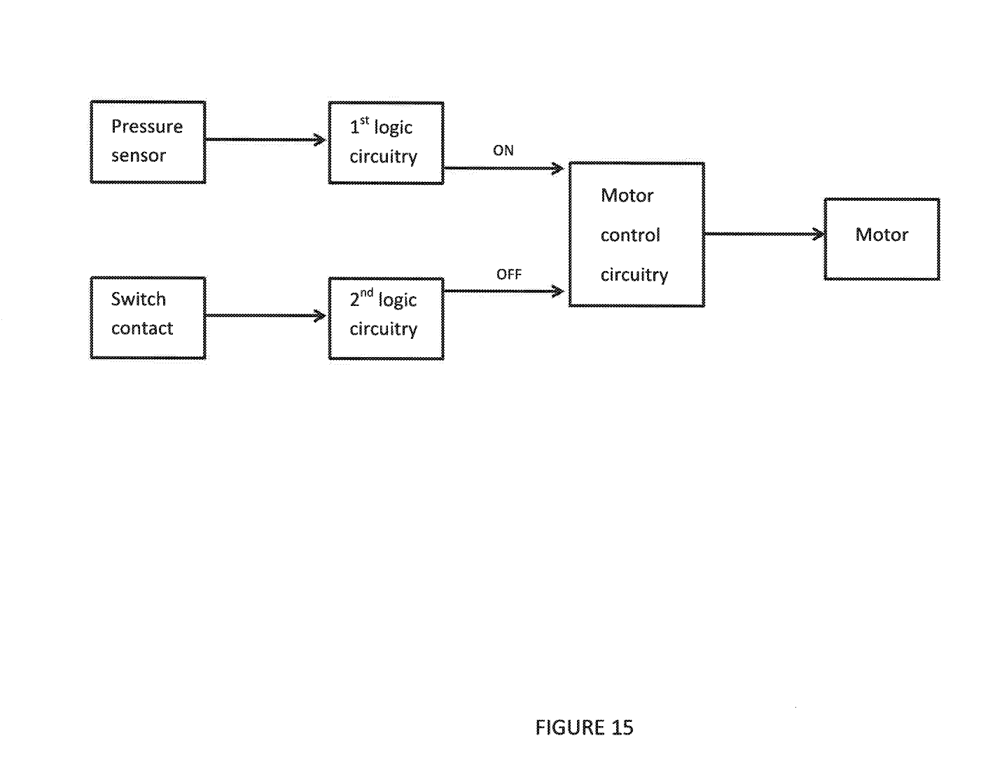

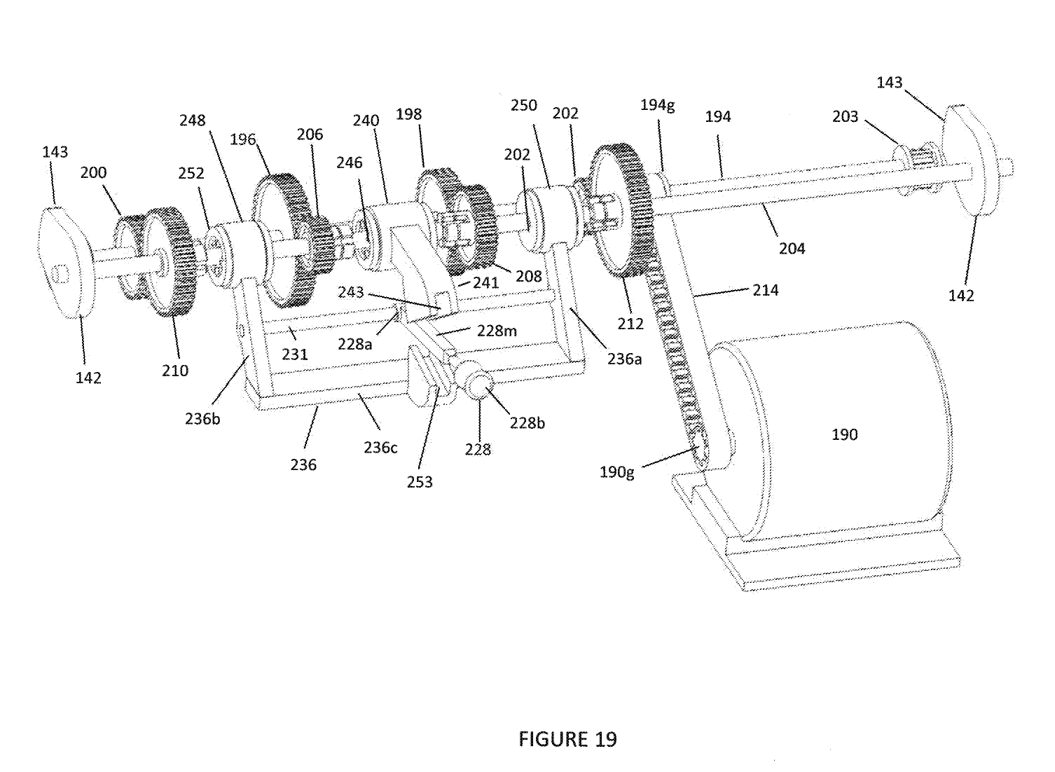

With further reference to FIG. 11 and the flow diagram of FIG. 15, when a pet steps on a discrete pad 86 above the platform surface 12a, a first voltage signal 126a is generated by the pressure sensor 124. If the pet steps off the discrete pad 86 a second voltage signal 126b is created by the pressure sensor 124 In response to the first signal 128a, first logic circuitry sends a signal to motor control circuitry 129 which powers up the system 10 in a standby mode. In response to the second signal 126b, second logic circuitry 128b sends a signal to the motor control circuitry 129 which switches the motor 190. With reference to FIGS. 16 and 17, with the motor turning, a drive gear 190g begins rotating. This, in turn, rotates a motor drive belt 214 that transfers energy to a shaft 194 which rotates drive shaft transmission gears 196, 198, 200 & 202. As illustrated in FIG. 19, power is then transferred to cam shaft transmission gears 206, 208, 210 & 212 to rotate cam shaft 204, cam 142, primary roller drive gear 203, roller belt 107, tension pulley 108, roller drive gear 101, roller shafts 100 and rollers 17a & 17b. Rollers 17a and 17b provide motive force to displace both the cover substrate 20 and the receiving substrate 16 as afore described. This motion seals layer 44a to layer 48a and seals layer 44b to layer 48b.

The receiving substrate 16 includes a series of transverse adhesive layer segments 70′ oriented perpendicular to the direction of motion of the receiving substrate 16 to create transverse seals 130 for the bag 32 as more fully described herein. A cam lobe 143 as shown in FIG. 19 is positioned to rotate a rocker arm 146 shown in FIG. 17 about a pivot point 151 to raise the press bar 133 from the press plate 13 and. The cam lobe 143 further rotates the rocker arm 146 to lower a press bar 133 (see FIG. 3) against the press plate 13. With this action the cover substrate 20 and the receiving substrate 16 are joined via an adhesive layer segment 70′ and the bag is placed in the repository 96. Once the sealed bag is placed in the repository and a next discrete pad 86 is moved into position on the platform 12, the motor 190 is switched off by the motor control circuitry.

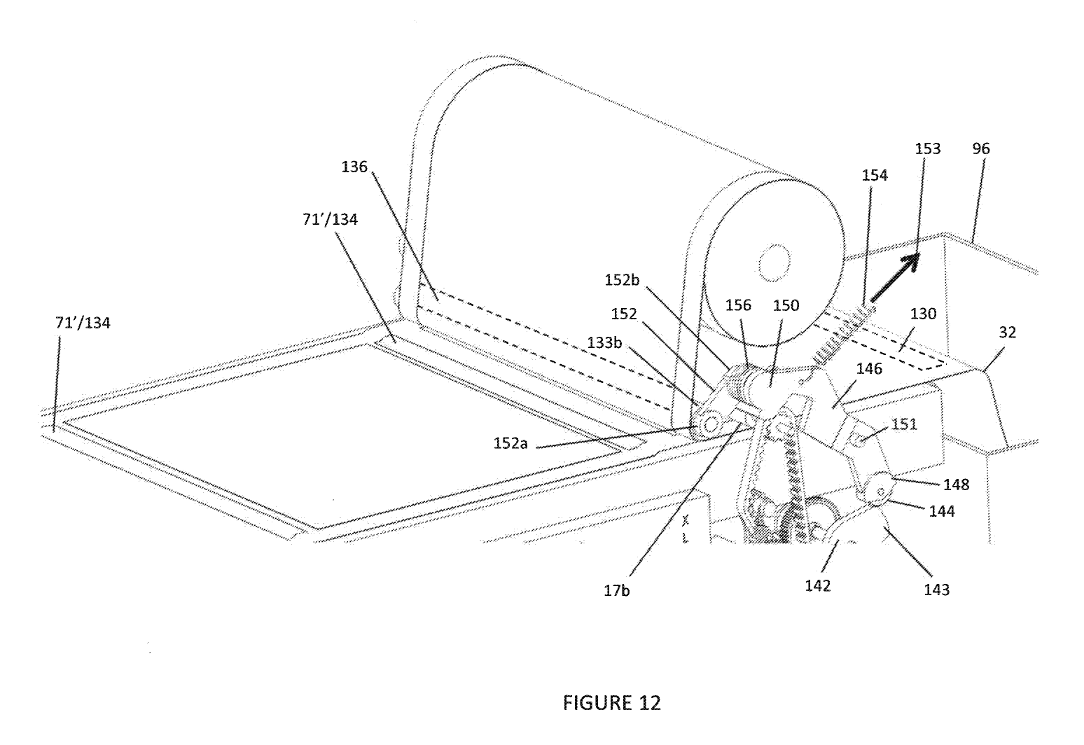

With regard to the transverse adhesive segments 70′ shown in FIG. 4, in addition to the outer region edge seals 66a, 66b, the system 10 also creates a series of spaced apart pairs of seals 130 each transverse to the edge seals. The transverse seals 130 extend to the edge seals so that the combination of a pair of edge seals 66a, 66b and a pair of seals 130 completely enclose contents of a bag 32. As shown in FIG. 12, each transverse seal 130 comprises a portion 134 of the receiving substrate and a portion 136 of the cover substrate which are bonded to one another via one of the adhesive segments 70′.

With reference to FIGS. 12, 13, 16 and 17, in an example embodiment the system 10 forms the seals 130 with a cam driven press 132 which undergoes cyclic motion to form a series of spaced apart pairs of transverse seals 130 as the substrates are conveyed by the rollers. As each portion 136 of the cover substrate becomes positioned along a portion of a receiving substrate, pressure is applied to the adjoining substrates so that the intervening transverse adhesive layer segments 70′ bond the portions 134, 136 of the substrates together. Each seal 130 borders a receiving region 26. In the system 10 the seals 130 are formed after the portions 134, 136 move away from the platform, then between and then past the rollers 17a, 17b. Collectively the pair of seals 66a, 66b and the pair of seals 130 formed about each receiving region 26 provide a continuous air tight perimeter seal around the bag/package 32.

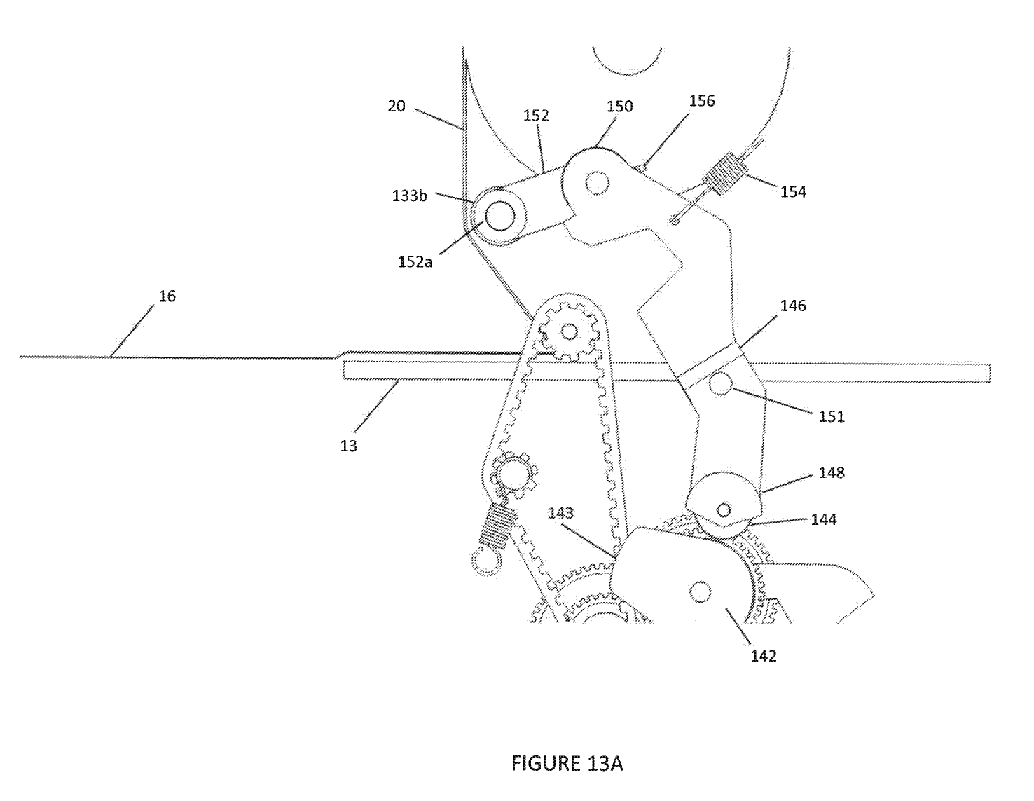

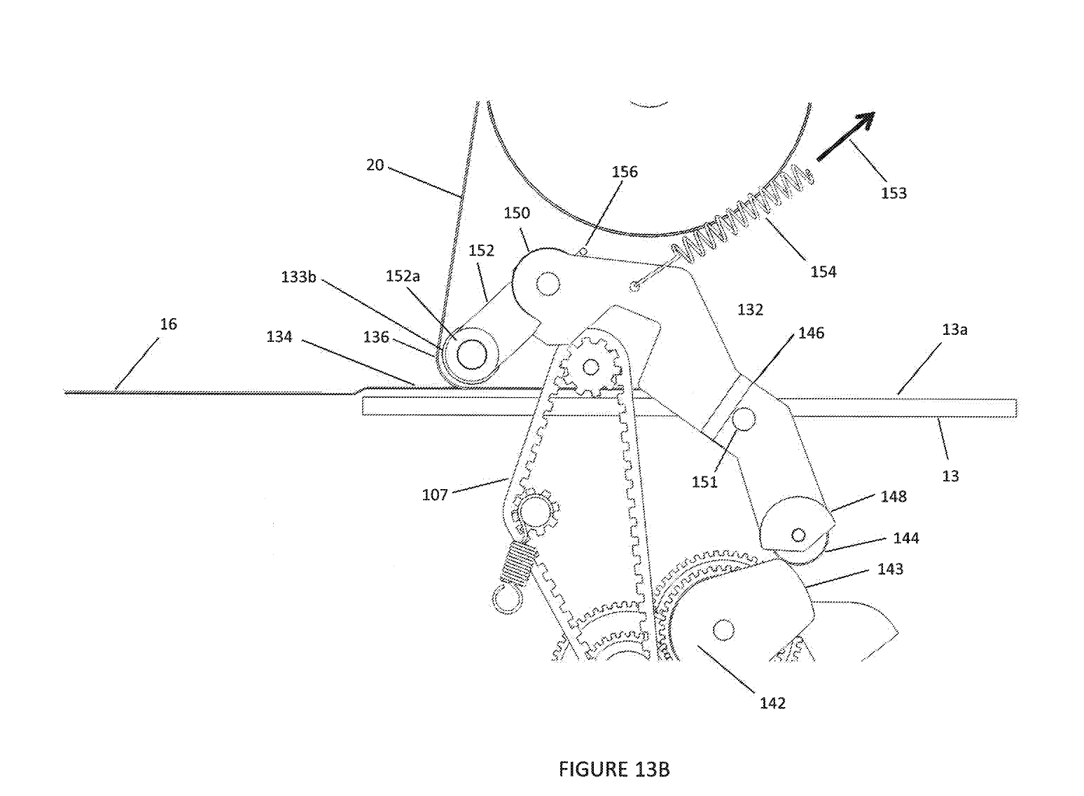

The cam driven press 132 comprises a press bar 133. FIG. 12 illustrates the press bar 133 in a sealing position for pressing against the upper surface 13a of the press plate 13 (not shown). As further illustrated in FIGS. 13A and 13B, the press bar 133 is rotatably mounted to turn with the rocker arm 146 about the pivot point 151, allowing the cam to space the press bar 133 away from the surface 13a (see FIG. 13A) and to press the bar 133 against the surface 13a. With this degree of rotational freedom, the press bar can be positioned away from the surface 13a, allowing portions 134, 136 of the substrates 16, 20 to move between the press bar and the surface 13a. This rotational freedom of the press bar 133 prevents the press bar from binding the portions 134, 136 or otherwise impeding sliding movement of the substrates as the rollers convey the substrates. The substrate portions 134, 136 that are sealed to one another are positioned between the press bar 133 and the press plate 13 to create the seal 130. In FIG. 13A the press bar 133 is in a spaced away position relative to the press plate 13 as the receiving region 26 (of the portion 134) and part of the portion 136 of the cover substrate both pass under the press bar 133.

The press 132 operates with movement of cams 142, each having a lobe, mounted for rotation on a variable speed cam shaft 204. See, again, FIG. 17. A pair of rocker arms 146 each having first and second opposing ends 148, 150 are mounted along opposite sides of the system 10 (e.g., on the press plate 13) to rotate about the pivot points 151. The view of FIG. 12 illustrates one rocker arm 146 and other components of the press 132 along one side of the press plate 13 which operate cooperatively with the press bar 133 to form the seals 130. It is to be understood that, although not described in detail, a similar arrangement is provided on the opposite side of the press plate, consistent with the partial view of FIG. 17. Although the description references a set of components on one side of the system 10, the description applies to operation of components on either side of the system in conjunction with the press bar 133 and the cam shaft 204.

Each rocker arm 146 transfers movement from the cam 142 to the press bar 133. A roller 144 is rotatably affixed to the first end 148 of the rocker arm and the cam 142 is positioned for movement against a rotatable surface of the roller 144. As the cam rotates, the lobe 143 periodically comes into contact with the roller 144. As the lobe 143 of the rotating cam 142 moves against the rotatable surface of the roller 144, both the roller and the end 148 of the rocker arm 146 are displaced. Consequently, with the second end 150 of the rocker arm coupled to the press bar 133, rotation of the lobe 143 moves the press bar 133 in a cyclic manner between the sealing position and the position spaced away from the press plate 13.

To facilitate reciprocal movement of the press bar 133, the bar is coupled to a spring 154 which is tensioned to apply a force 153 which returns the press bar 133 to the position spaced away from the press plate 13 when the cam lobe is not forcing the press bar against the press plate. The spring 154 also provides a continual force which urges a contacting surface of the roller 144 to continuously move along a contacting surface of the cam 142.

As the press undergoes cyclic movement, movement of the lobe 143 of the rotating cam 142 along the rotatable surface of the roller 144 causes the press bar 133 to remain in rolling engagement against the upper surface 13a of the press plate 13 for a period of time determined by the shape of the lobe 143. When the cam includes a lobe having a relatively long, flat shape which forces the press bar to remain against the surface 13a along region 92 of substrate 16, it is during the entire portion of the cyclic period in which the portion of the lobe having the relatively long, flat shape is in contact with the rotatable surface of the roller 144, that the press is forced against the surface 13a. On the other hand, when the cam includes a lobe having a relatively short, pointed shape, and it is only the tip of the pointed shape which extends the press bar 133 against the surface 13a, then it is only during the portion of the cyclic period in which the point of the pointed shape of the lobe is in contact with the rotatable surface of the roller 144, that the press is forced against the surface 13a. Consequently, for a given cycle period the duration of time in which the press bar 133 can be forced to remain against the surface 13a can vary based on the shape of the cam lobe 143. The duration of time that the press bar 133 remains against the surface 13a can be limited to the amount of time required to form each transverse seal 130, it being recognized that the time required to form each seal may be a function of the force applied by the press bar 133 to the transverse adhesive layer segments 70′ sandwiched between the portions of the substrates 16 and 20 with which each seal 130 is formed. The force applied by the press bar can be chosen in view of safety considerations, which considerations include the speed at which the rollers 17a, 17b move the substrate material over the surface 13a and the maximum amount of force which is to be applied by the press bar.

The press 132 may be configured in numerous ways to apply a desired force to form the seals 130. The cam lobe 143 may have a relatively steep slope as shown in the figures, resulting in a tip having a relatively long arc length, e.g., extending sixty degrees. This produces a suitable dwell time during which the press is positioned to apply a sealing force against the transverse adhesive layer segments 70′.

The illustrated press 132 includes a safety mechanism comprising two extension arms 152, each positioned intermediate the press bar 133 and one of the rocker arms 146 to which the press bar is connected. The press bar 133 has first and second opposing ends 133a, 133b and the extension arm has first and second opposing ends 152a, 152b. The first end 133a of the press bar is rotatably coupled to a first end 152a of one extension arm and the second end 133b of the press bar is rotatably coupled to the first end 152a of the other extension arm. With this arrangement the press bar can freely rotate about the axis, A. The second end 152b of each extension arm is rotatably coupled to the second end 150 of one of the rocker arms 146. See, again, FIGS. 12 and 13. During normal operation of the press 132 a torsion spring 156 (see FIG. 12) provides tension to firmly secure the extension arm 152 in a fixed, non-rotatable position. That is, the spring prevents the extension arm 152 from rotating with respect to the rocker arm 146. Consequently, during normal sealing operations performed by the press 132, neither of the extension arms 152 can rotate about the second end 150 of the rocker arm 146 to which it is connected. On the other hand, if an appendage of a pet, e.g. a paw, becomes positioned under the press bar 133 while the bar is moving in a cyclic manner (e.g., from the position spaced away from the press plate 13 toward the sealing position), movement of the press bar toward the plate 13 can be limited and the force placed against the pet appendage can also be limited. As the press 132 imposes a force through the press bar 133 and against the appendage, resistance to movement of the press bar, i.e., due to the presence of the appendage, results in application of the imposed force about the second end 150 of each rocker arm, which force is in a direction counter to the force exerted by the torsion spring 156. When the torque developed by the press about the second end 150 of each rocker arm exceeds an opposing torque about the second end 150 due to the force of the torsion spring 156, each extension arm 152 begins to rotate about the second end 150 of the associated rocker arm 146. Thus, as the cam continues to displace the rocker arm 146 while the appendage is in the path of the press bar 133, the movement of the rocker arm 146 results in rotation of the extension arm 152 instead of resulting solely in movement of the press bar 133. Consequently the force applied by the press bar 133 against the intervening appendage does not reach the level of force normally applied against the surface 13a. The amount of force applied against the appendage is limited in accord with the strength of the torsion spring 156 and movement of the press bar is limited as well.

Since each periodic segment 91 comprises a length 98 of each substrate 16, 20 determined in accord with a selected platform size, a corresponding time period is determined for the duration of each cam cycle. The time period of each cycle is determined to assure that the substrates 16, 20 are moved across the platform 12 and plate 13 a distance which corresponds to the uniform length 98 of the periodic segments 91 in the roll 16r as defined for the selected platform size.

Relative movement of the rollers and the cam are derived from a common drive shaft and operation of a gear system. The cam cycle period is adjustable based on selectable gear ratios to control the cam cycle period relative to the speed of the rollers. This assures movement of a proper amount of substrate material for a given platform size and the consequent length 98 of the chosen size of the periodic segments 91 of substrate material.

Each periodic segment 91 is of a predefined length 98 that corresponds to a chosen platform size. For the illustrated embodiments, the time period associated with cyclic movement of the press bar 133, i.e., the time of a period of cam rotation, is synchronized with the speed at which the rollers 17a, 17b move the substrates 16, 20 so that the substrates 16, 20 each move the predefined length 98 during the time period of a cam rotation. To effect appropriate adjustment of the timing to achieve desired synchrony, selectable gear ratios in the gear system adjust the time period of cam rotation. For each platform size appropriate gears are selected to set a predetermined time period for a complete cam cycle equal to the time period required for movement of a selected length 98 of substrates in conformity with the selected platform size. Thus the time period of each cam cycle corresponds to the amount of time needed to pass the correct length 98 of substrate materials under the rollers 17a, 17b while operating the press bar 133 to make a pair of transverse seals 130 in the same selected length 98. For each cam cycle, the movement of the periodic segments 91 is synchronized with cyclic movement of the press bar to provide a fully sealed bag.

For embodiments where the receiving substrate 16 includes discrete pads 86, e.g., positioned only in the receiving regions 26, which are formed on periodic substrate segments 91 of a length 98 (in accord with a chosen platform size), as well as for embodiments where the substrate 16 does not include discrete pads, the transverse adhesive layer segments 70′ are formed on a surface of the receiving substrate 16 or on a surface of the cover substrate 20 or on surfaces of both substrates. For embodiments where the substrate 16 does not include discrete pads, the transverse adhesive layer segments 70′ are formed on a surface of the receiving substrate 16 or on a surface of the cover substrate 20 or on surfaces of both substrates. If the receiving substrate 16 includes a continuous layer of fluid absorbent material 84 instead of the discrete pads, the segment 70′ may be applied directly over the fluid absorbent material 84 so that transverse seals 130 are formed between the fluid absorbent material 84 and the cover substrate 20. In another design, cut-out regions may be formed in the fluid absorbent material 84 with the segment 70′ formed in the cut-out regions.

Further, the edge region adhesive layer segments 70 and the transverse adhesive layer segments 70′ for the seals 130 may be simultaneously formed as one layer or level of adhesive on either or both of the substrates 16, 20. In certain embodiments, particularly those with which discrete pads 86 are formed on the substrate 16, it may be necessary to position one or both of the substrates 16, 20 with respect to the position of the press bar 133. This can assure that periodic features along one or both substrates are spatially in phase as they come together under the sealing action undertaken by the press bar 133 and thereby properly form a pair of transverse seals 130 for each bag 32.

Embodiments of the invention are also contemplated where neither of the substrates 16, needs to be positioned to coordinate with movement of the press bar 133 as the seals 130 are created. For example, when both the receiving substrate 16 and the cover substrate 20 have continuous surface features (e.g, a continuous layer of absorbent material on the substrate 16 and a continuous layer of adhesive material on the substrate 20), neither substrate needs to be positioned in accord with the movement of the press bar 130. It is also noted that in other embodiments the adhesive could be applied in spaced apart regions, i.e., intermittently along the entire length of a substrate, while the press bar spans a sufficient length (i.e., in the x-direction) to assure contact with sufficient adhesive to form the transverse seals 130.

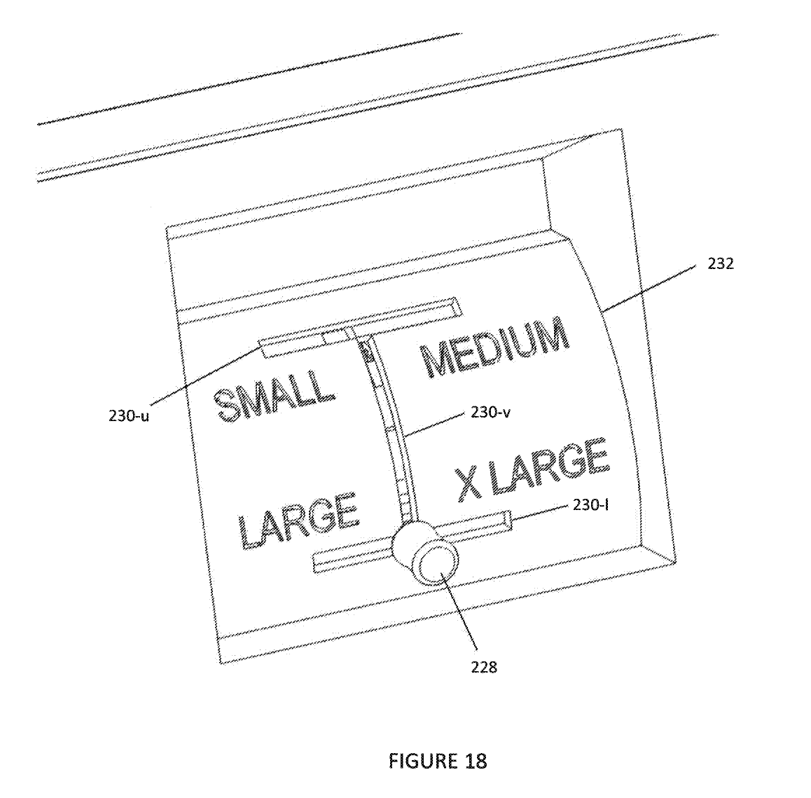

The embodiment of the system 10 as shown in FIGS. 16 and 17 incorporates a single motor 190 that drives movement of both substrates 16, 20 and the press 132. With the cycle time of the press 132 fixed with respect to an input speed (ωₘₒₜₒᵣ) of the motor 190, the rotational speed (ωₘₒₜₒᵣ) of the rollers 17a, 17b is proportional to and fixed with respect to the cam speed (ω_{cam}). With the cam 142 controlling operation of the press 132, the period of cam rotation is synchronized with movement of a given length 98 of a segment 91 under the rollers 17a, 17b. Given this relationship between a given length 98 of the segments 91 and the period of the cam 142, a transmission 192 (see, also, FIGS. 18-22) accommodates different rolls 16r having segments 91 of different predefined lengths 98. The transmission 192 enables selection of one size among the several sizes of rolls 16r where the different sizes are each characterized by a series of segments each of predefined length based on the selected size for a pet. That is, with the platform 12 providing a selection of adjustable pet sizes (e.g., by sliding movement of one platform segment 120 with respect to the other platform segment 122), the transmission 192 can be adjusted to unroll substrate segments of the appropriate pre-selected length 98 for each selected platform size by adjusting the rotational speed (ω_{cam}) of the cam 142.

A shifting mechanism for the transmission 192 is illustrated in FIGS. 18 and 19. A shift handle 228, operatively coupled to operate the transmission 192, has a first end 228a which is coupled to a guide rod 231. The guide rod is positioned along a direction parallel to the cam shaft 204. The first end 228a of the shift handle is both rotatable about the guide rod 231 and moveable along the guide rod. A second end 228b of the shift handle 228 extends through an “H” pattern of connected slots 230 formed in a guide plate 232. The connected slots include an upper horizontal slot 230-u, a lower horizontal slot 230-1 and a vertical slot 230-v extending between the horizontal slots. The second end 228b of the shift handle 228 can be moved along the pattern of connected slots 230 to guide movement of the shift handle when selecting a desired gear ratio for the transmission 192. The plate 232 is suitably labeled to inform an operator of the system 10 of appropriate shift positions for each platform size. Movement of the handle 228 to a particular position (e.g., one of the four size positions ranging from Small to Extra Large) adjusts the gear ratio of the transmission to provide an appropriate rotational speed (ω_{cam}) of the cam 142 in order to unroll substrate segments of an appropriate length 98 in synchrony with each cam cycle period. Irrespective of the adjustable cam speed, the rollers 17a, 17b always rotate at the same constant speed (ωᵣₒₗₗₑᵣₛ). On the other hand, changing the gear ratio in use by the transmission 192 results in selection of a particular cam cycle speed, ω_{cam}, which provides a cam cycle period in accord with the selected pet size.

A roller drive shaft 194, which carries a set of drive shaft transmission gears 196, 198, 200, 202, is coupled to the motor 190 via a toothed motor drive belt 214. The belt 214 is coupled to the motor 190 via a motor gear 190g and is coupled to the shaft 194 via a shaft gear 190g. The gears 190g and 194g are sized to provide a suitable gear ratio in view of the motor speed and desired rotational speed of the drive shaft 194. Each secondary roller drive gear 101 is coupled for rotation to a primary roller drive gear 203 via a roller belt 107 to turn the rollers 17a, 17b. The primary roller drive gears 203 are affixed to the drive shaft 194. In the illustrated design the gears 203 are each positioned at an opposite end of the shaft 194.

A cam shaft 204 carries a set of cam shaft transmission gears 206, 208, 210, 212 which are each meshed with one of the drive shaft transmission gears 196, 198, 200, 202 for rotation powered by the drive shaft 194 and motor 190. The four drive shaft transmission gears 196, 198, 200, 202 are selectable for engagement with the cam shaft to drive the cam shaft 204 with one of four gear ratios. This enables the cam shaft 204 to be driven at one of four selected speeds in accord with a pet size selection made with the shifter 226. Arrows 216, 217, 218, 219, 220 and 222 are shown in the figures to indicate exemplary directions of rotation of individual components with respect to rotation of the motor 190.

In this exemplary embodiment the drive shaft transmission gears 196, 198, 200, 202 are coupled to invariably rotate with the roller drive shaft 194. As they turn with the drive shaft 194 the drive shaft transmission gears each turn one of the cam shaft transmission gears 206, 208, 210 or 212. However, the cam shaft transmission gears are not fixed to always rotate the cam shaft 204. Rather, each of the cam shaft transmission gears 206, 208, 210, 212 can be selectively engaged or disengaged for rotation of the cam shaft 204. When disengaged the cam shaft transmission gears can freely rotate with respect to the cam shaft 204. Each cam shaft transmission gear can be separately engaged to turn the cam shaft 204. Adjacent each of the cam shaft gears 206, 208, 210, 212 is an associated one of four fixed collars 224. Each collar 224 is invariably fixed to the cam shaft 204 for rotation therewith.

Although they are free to rotate, each of the cam shaft gears 206, 208, 210, 212 is fixed in position along the cam shaft between one of the fixed collars 224 and one of four rings 225 also fixed in position along the cam shaft. In this example, the rings 225 are coupled to invariably rotate with the cam shaft. All of the cam shaft transmission gears 206, 208, 210, 212 are mounted between one of the fixed collars 224 and one of the rings 225 to prevent sliding movement of the gears along the cam shaft 204 while permitting the gears to be selectably engaged with the fixed collars to drive rotation of the shaft 204 or to be selectably disengaged from the fixed collars so as to freely turn with respect to the cam shaft 204.

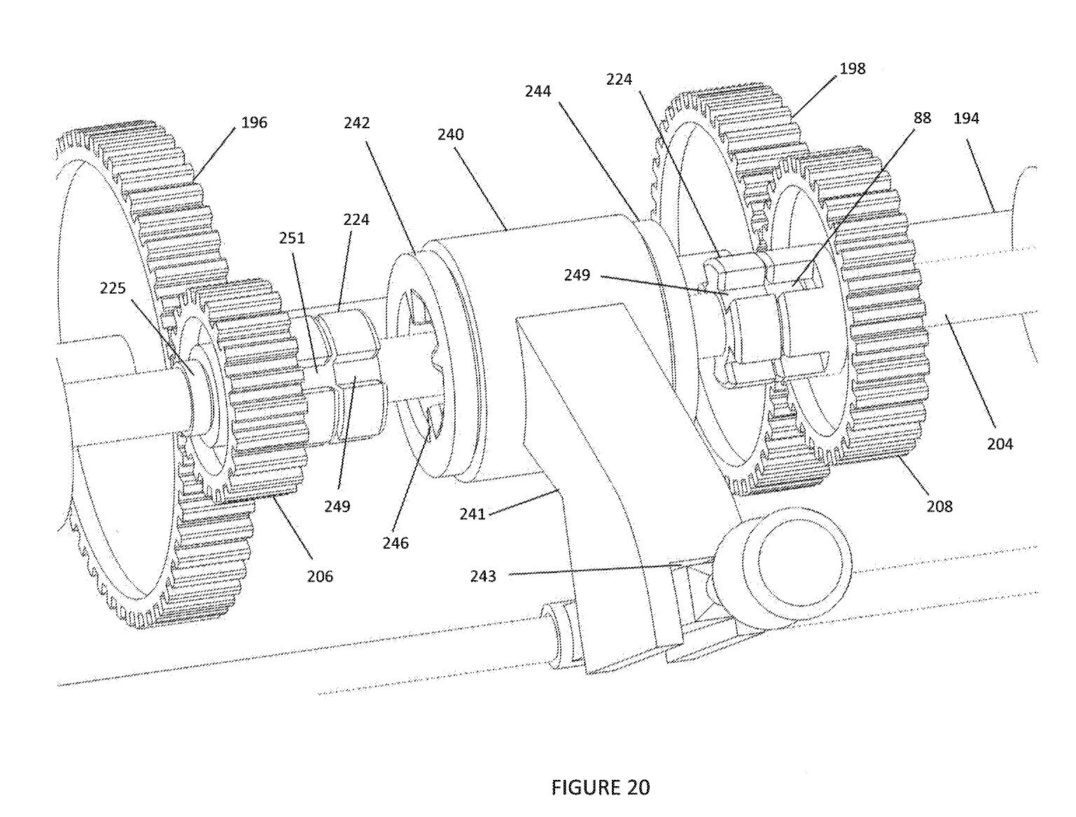

With reference to FIG. 20, To effect selection of only one cam shaft transmission gear 206, 208, 210 or 212, the transmission 192 has a gear changing mechanism which operates based on sliding movement of keys within keyways to lock a desired one of the gears 206, 208, 210 or 212 to an adjacent fixed collar 224 and thereby drive rotation of the cam shaft 204 with the selected gear. Each of the fixed collars 224 includes a series of collar keyways 249 and each of the cam shaft transmission gears 206, 208, 210, 212 includes a similar series of gear keyways 251. The keyways in each series of keyways 249 in each fixed collar 224 can be aligned with one of the gear keyways 251 of the similar series formed in the adjacent gear 206, 208, 210 or 212. In the example embodiment all of the collar keyways 249 and gear keyways 251 extend longitudinally along the axis about which the shaft 204 rotates. With free rotation of the gears 206, 208, 210, 212 each gear keyway 251 formed in a gear can be aligned with a keyway 249 formed in a fixed collar to create a series of extended keyways which span a collar and an adjacent gear. The transmission system further includes a first pair of sliding key collars 242, 244 and a second pair of sliding key collars 252, 254. The sliding key collars are free to move along the axis about which the cam shaft rotates to effect insertion of keys within keyways.

Unless a particular key collar is engaged with an associated gear, the cam shaft 204 freely rotates within the key collar. Generally, each of the sliding key collars is a cylindrical body concentrically mounted about the cam shaft 204 to freely rotate about the cam shaft. Each sliding key collar includes a series of keys 246 operatively positioned on the key collar to effect selective insertion of each key 246 within a pair of keyways 249, 251 in an adjacent fixed collar and gear. Like the keyways 249, 251, the keys 246 also extend longitudinally along the axis about which the shaft 204 rotates so that they are insertable within the keyways 249, 251. Insertion is had by moving a key collar along the axis about which the cam shaft rotates and along the keyways by movement of the shifter handle 228. The keys and keyways have complementary shapes so that insertion of the keys 246 within the keyways 249, 251 locks the gear associated with the keyways gear 251 to an adjoining fixed collar 224. This results in an engagement of the cam shaft transmission gear with the cam shaft to drive rotation of the cams 142. Unless the keys 246 of a key collar are so inserted into the complimentary collar keyway 249 and gear keyway 251 to effect engagement with the associated gear, the cam shaft 204 freely rotates within the key collar.

Each sliding key collar is rotatably mounted within a key collar housing 240 and each key collar housing 240 is connected to a key collar bracket. With reference to FIGS. 19-22, the sliding key collars 242, 244 are mounted within one key collar housing 240 which is attached to a single arm key collar bracket 241. The bracket 241 extends from the housing 240 toward the shifter 226. Movement of the two key collars 242, 244 is had by engaging a mid portion 228m of the shifter 226 in a slotted opening 243 formed along an end 241a of the key collar bracket 241 which extends away from the key collars 242, 244. With this arrangement the shifter 226 may be locked in engagement with the key collar bracket 241 to slide the key collar housing 240 and associated key collars 242, 244 along the cam shaft 204. Sliding of the two key collars in one direction along the cam shaft 204 engages the keys 246 formed in one of the key collars 242, 244 within the collar keyway 249 and gear keyway 251 of one fixed collar 224 and the associated cam shaft transmission gear.

The sliding key collars 252, 254 are each mounted in separate key collar housings 248, 250 which are each attached to a different arm of a U shaped key collar bracket 236. A first arm 236a of the bracket 236 extends from the housing 248 and a second arm 236b extends from the housing 250. The arms are connected by a midsection 236c of the bracket 236 which includes a slotted opening 253 suitable for receiving the mid portion 228m of the shifter 226. Movement of the two key collars 252, 254 is had by engaging the mid portion 228m of the handle 228 in the opening 243 of the key collar bracket 236. With this arrangement the shift handle 228 may be locked in engagement with the key collar bracket 241 to slide both of the key collar housings 248, 250 and associated key collars 252, 254 along the cam shaft 204 to engage the keys 246 of one of the key collars 252, 254 within the keyways 249, 251 of a fixed collar 224 and an associated cam shaft transmission gear. The key collar brackets 236 and 241 are secured to one another or a housing of the system 10 to prevent rotation of the brackets while the sliding key collars 242, 244, 252, 254 are free to rotate with respect to the cam shaft 204 and while the shift handle 228 is rotated between the key collar brackets 236 and 241 for selective engagement in one of the slotted opening 243 or 253.

A feature of the transmission 192 is that the sliding movement of one pair of key collars 242, 244 is separately controlled relative to the sliding movement of the other pair of key collars 252, 254 even though all of the collars are on the same cam shaft 204 and engagement of all key collars is controlled by movement of the same shift handle 228. This is possible because the shift handle 228 can be rotated into a locking engagement in either one of two different key collar brackets 236, 240.

At any given time only one of the cam shaft transmission gears can be selectably engaged with a fixed collar 224 to rotate the cam shaft 204 as the roller drive shaft 194 is rotated under the power of the motor 190. Selective engagement of a single one of the cam shaft transmission gears 206, 208, 210, 212 to rotate the cam shaft 204 is effected with only one of the four collars 224 while the other cam shaft transmission gears remain disengaged. Depending on the selected platform size one of the four cam shaft gears 206, 208, 210, 212 is selected for a sliding engagement along the cam shaft 204 with the associated collar through movement of the shift handle 228. The cam shaft 204 turns via transfer of torque from the selected cam shaft transmission gear through the associated collar 224 to provide a predetermined rotational speed (ω_{cam}) to the cam shaft 204 and the associated cams 142 affixed thereto.

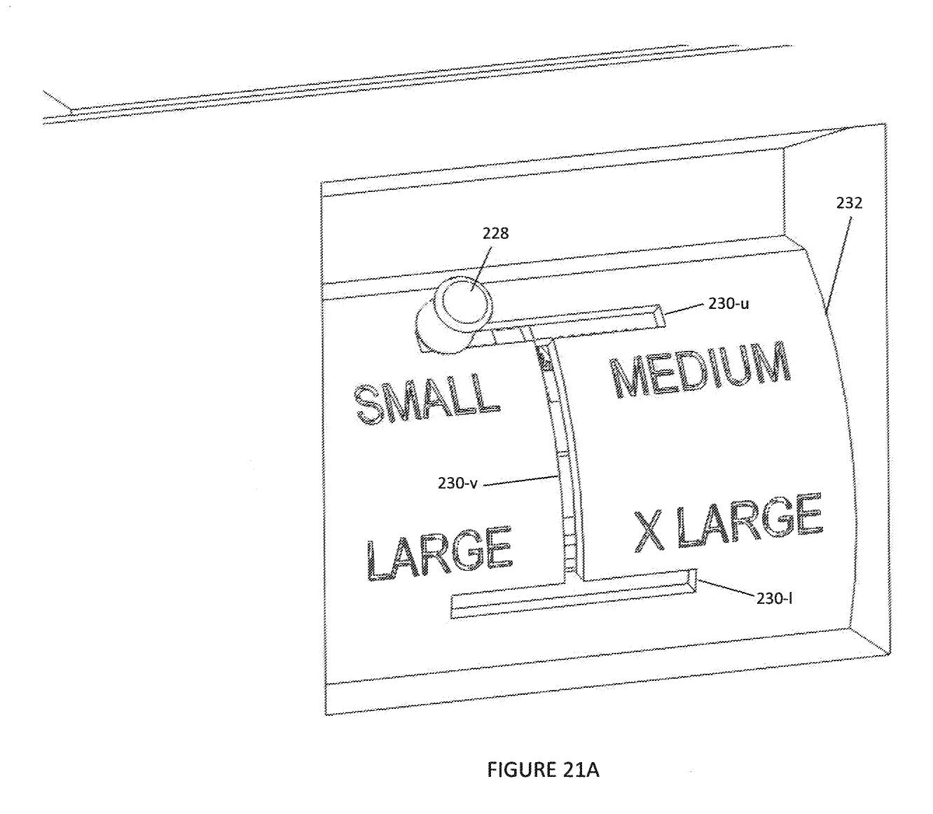

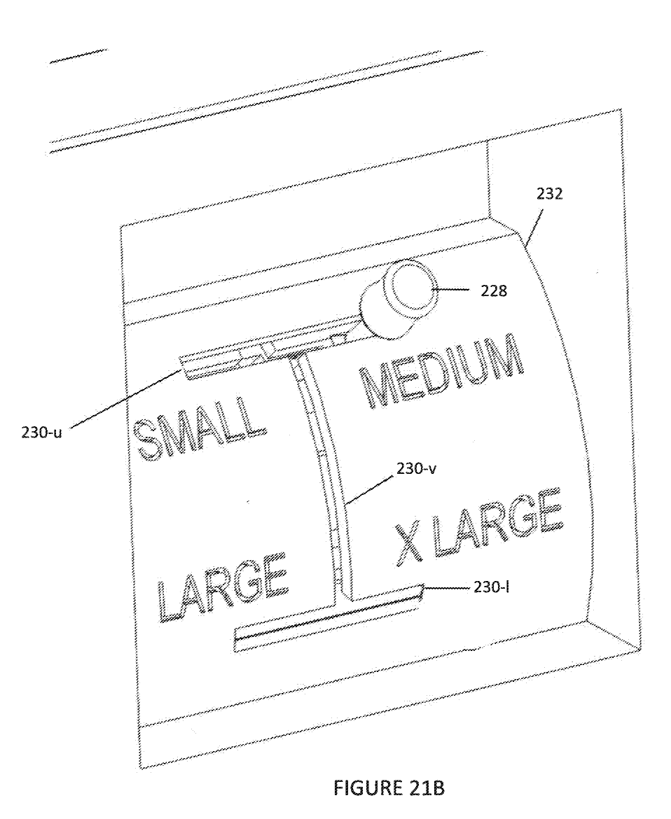

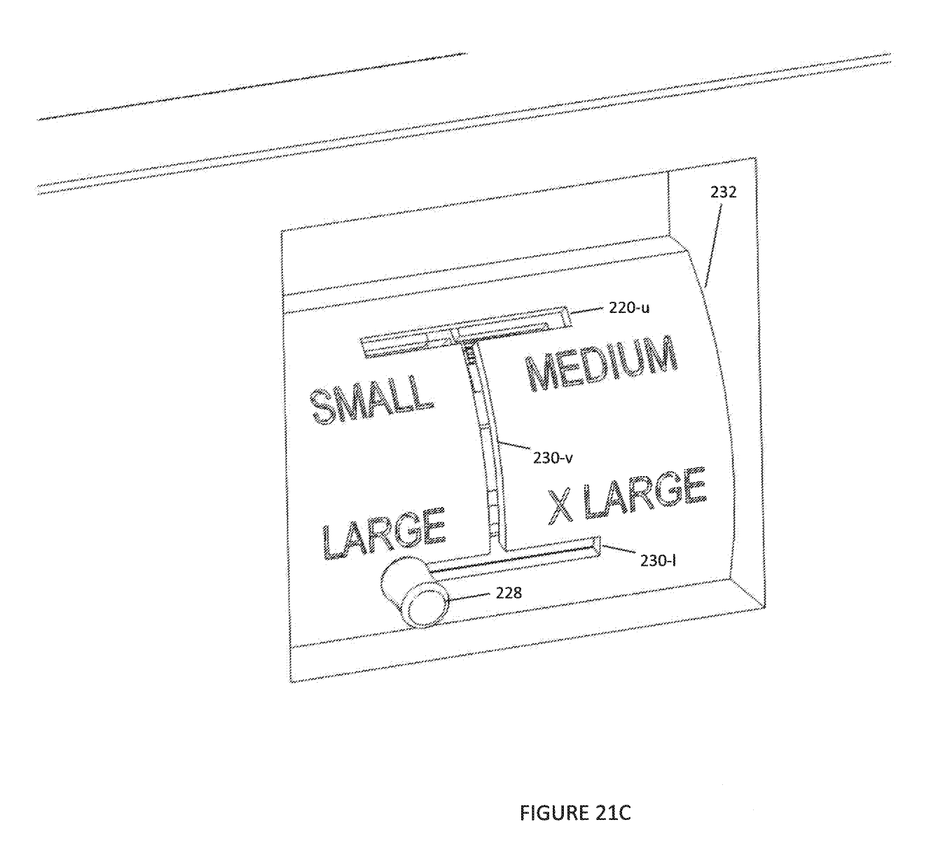

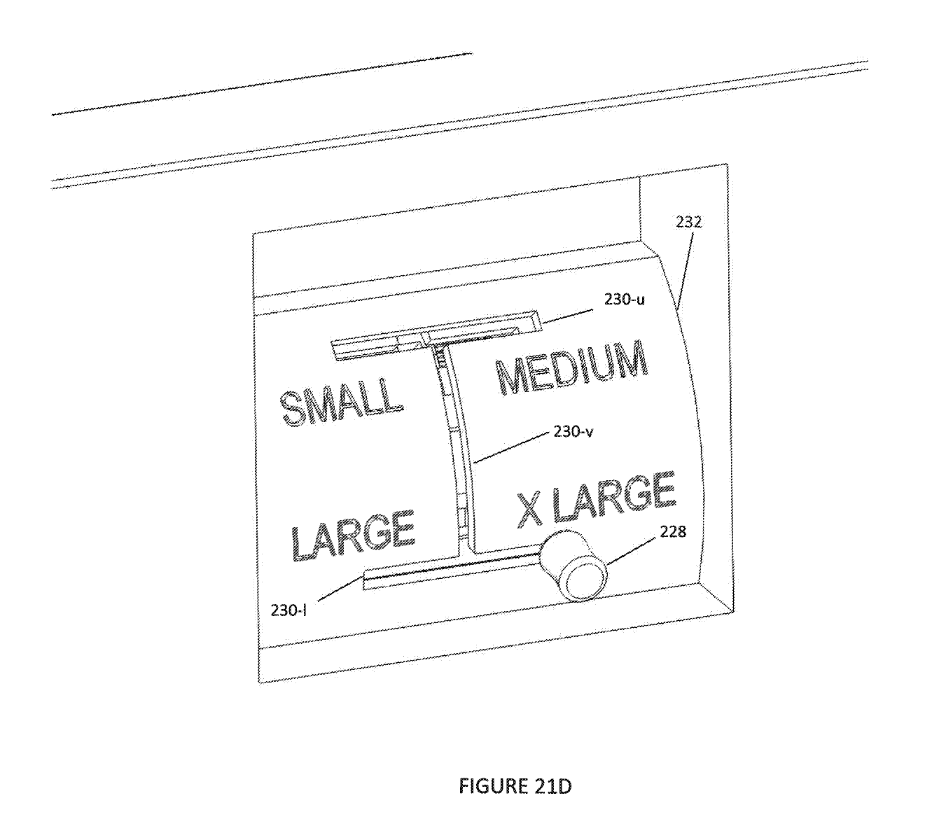

With the drive shaft transmission gears 196, 198, 200, 202 fixed to the roller drive shaft 194 for rotation therewith, selection of a cam shaft transmission gear 206, 208, 210 or 212 engages a pair of connected transmission gears to the cam shaft 204. The motor 190 drives the motor drive belt 214 that drives the roller drive shaft 194 which drives the cam shaft 204 via the selected transmission gear pair, which drives the cam shaft 204 at a speed determined by the gear ratios of the selected gear pair. The selectable gear pairs are, from left to right in FIGS. 19: 200, 210; 196, 206; 198, 208; and 202, 212. The angular speed of the cam shaft 204 and the attached cams 142 (ω_{cam}) is determined by the ratios of the gears within a selected pair. For example, with gear 196 being the largest of the drive shaft transmission gears and gear 206 being the smallest of the cam shaft transmission gears, selection of this pair of gears produces the fastest rotation of the cam 142, providing the smallest period of the cam 142 relative to the gear ratios provided by the other three pairs of gears. With each cycle of the system 10 corresponding to the period of cam rotation, and with the speed at which the substrates 16, 20 move under the rollers being constant for all size settings of the system 10, selection of a faster cam speed, ω_{cam}, results in the substrates 16, 20 traveling a relatively shorter distance through the system 10 for each cycle of the cam 142. This result provides segments 91 of a short length 98, relative to other size settings, suitable when the platform 12 is set to a Small size. Accordingly, this gear ratio is selected when the shift handle 228 is placed in the Small position shown in FIG. 21.

The position of any one of the four sliding key collars 242, 244, 252, 254 is set by raising or lowering the shift handle 228 along 230-v to place the handle 228 in locking engagement within one of the openings 243, 253 and then moving the handle to the left or right along one of the horizontal slots 230-u, 230-1 to a position which engages keys of one key collar within key slots of a fixed collar 224 and associated cam shaft transmission gear.

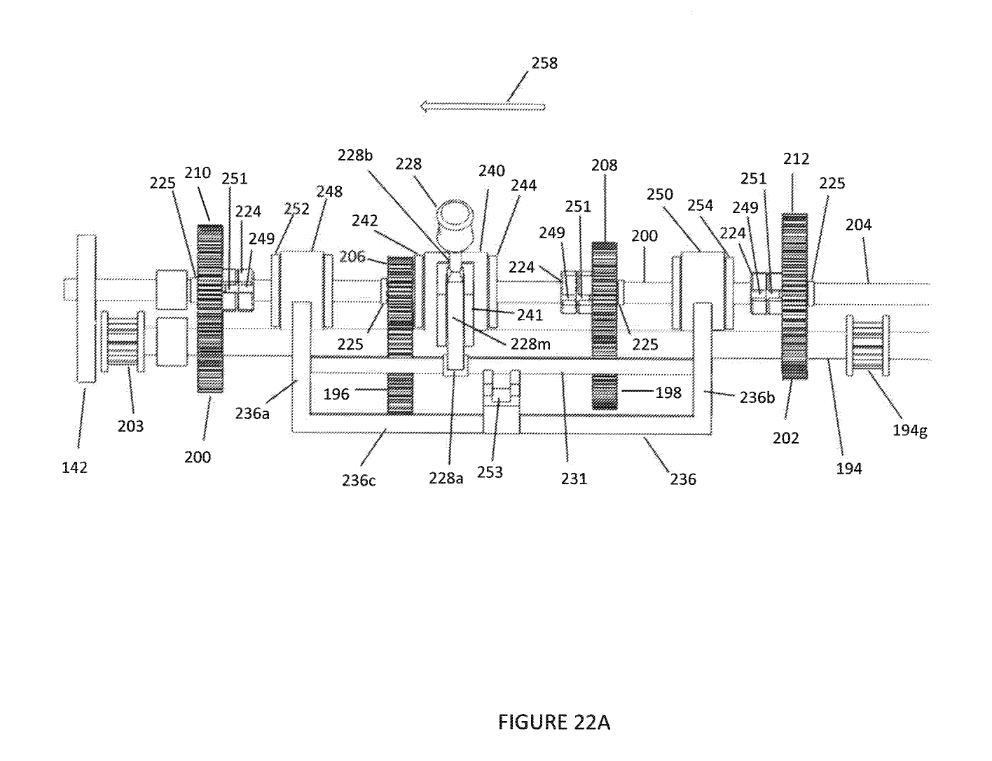

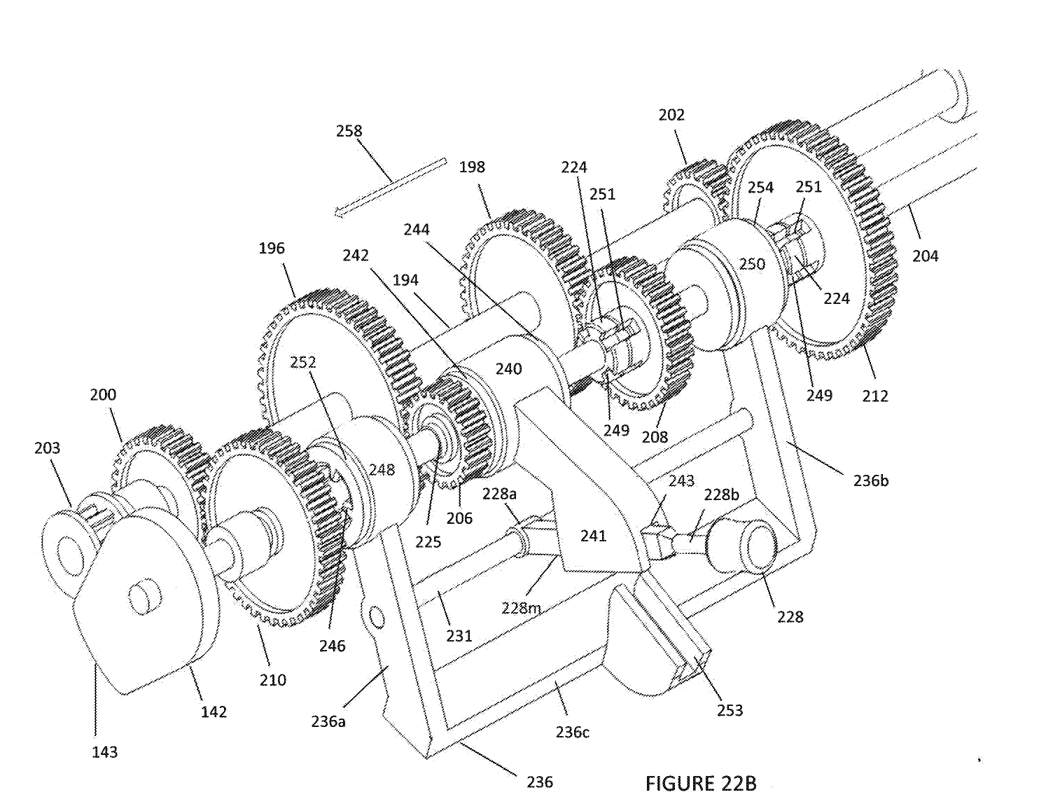

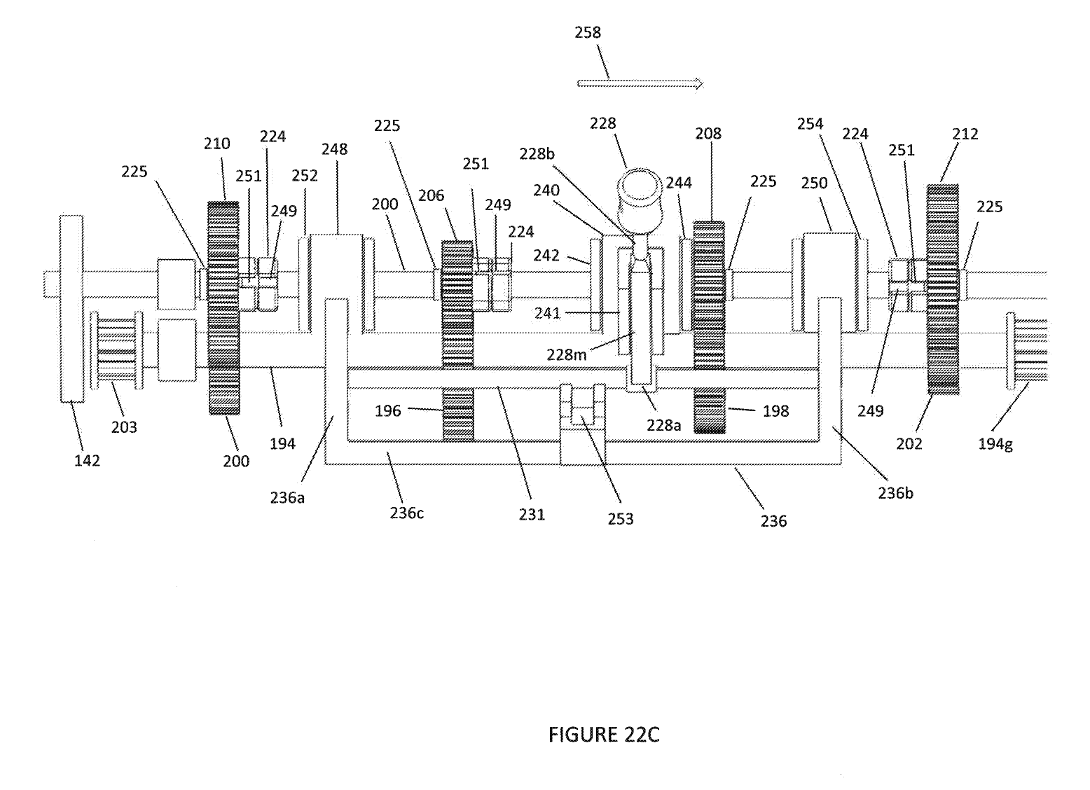

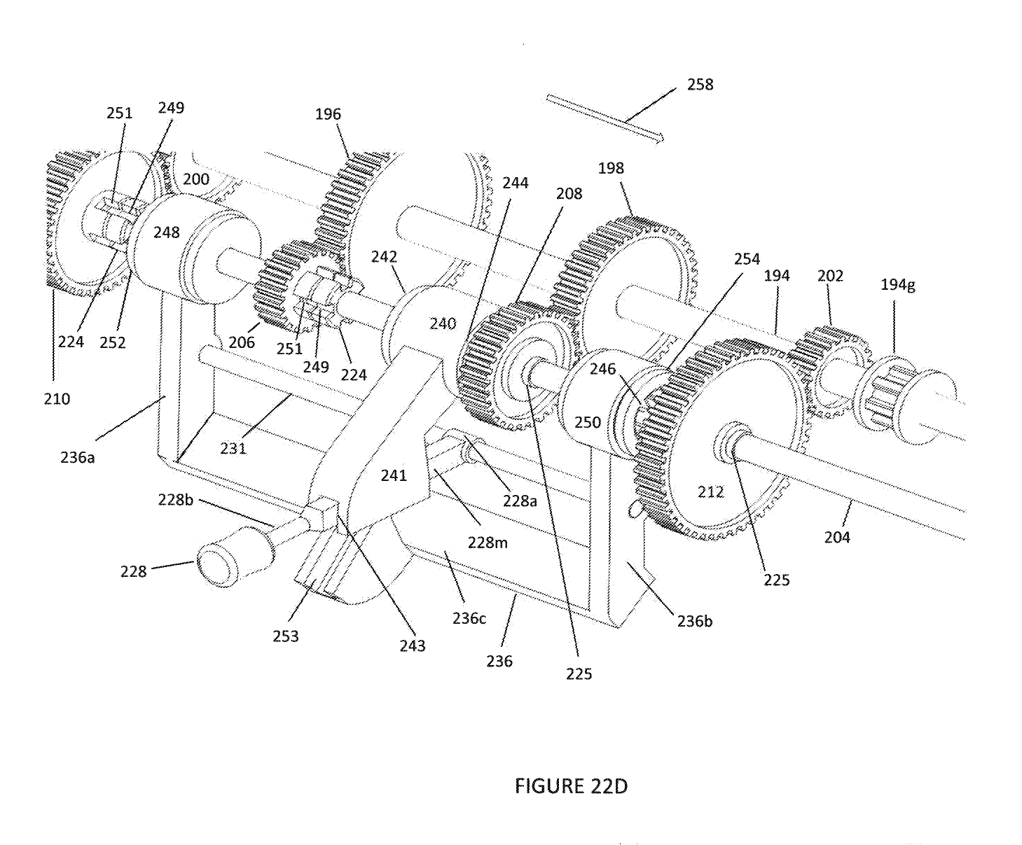

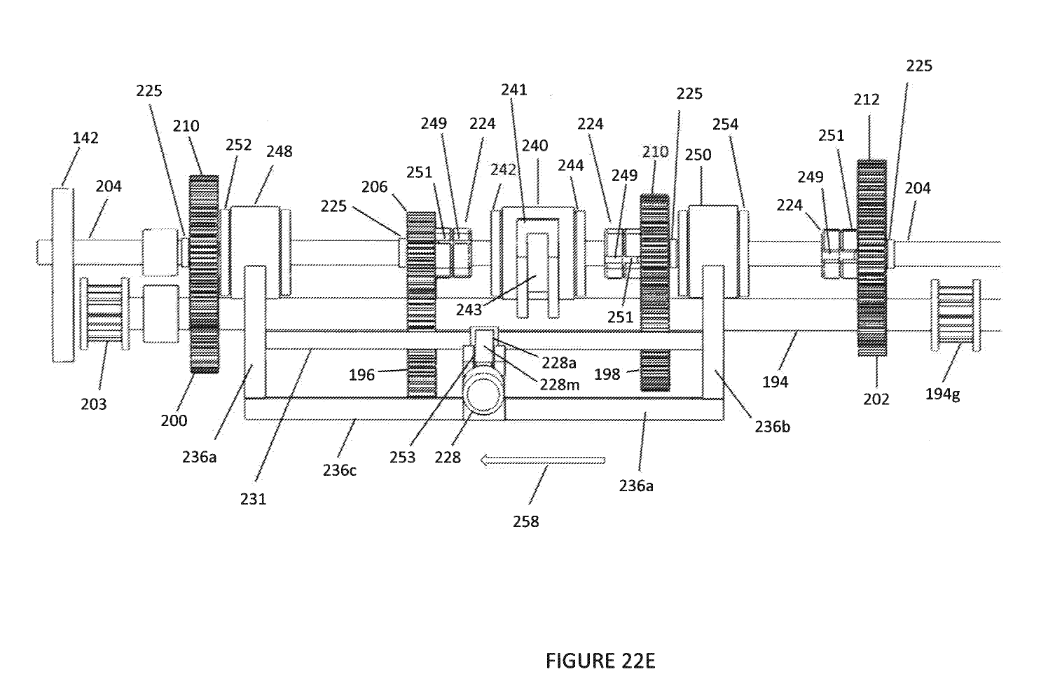

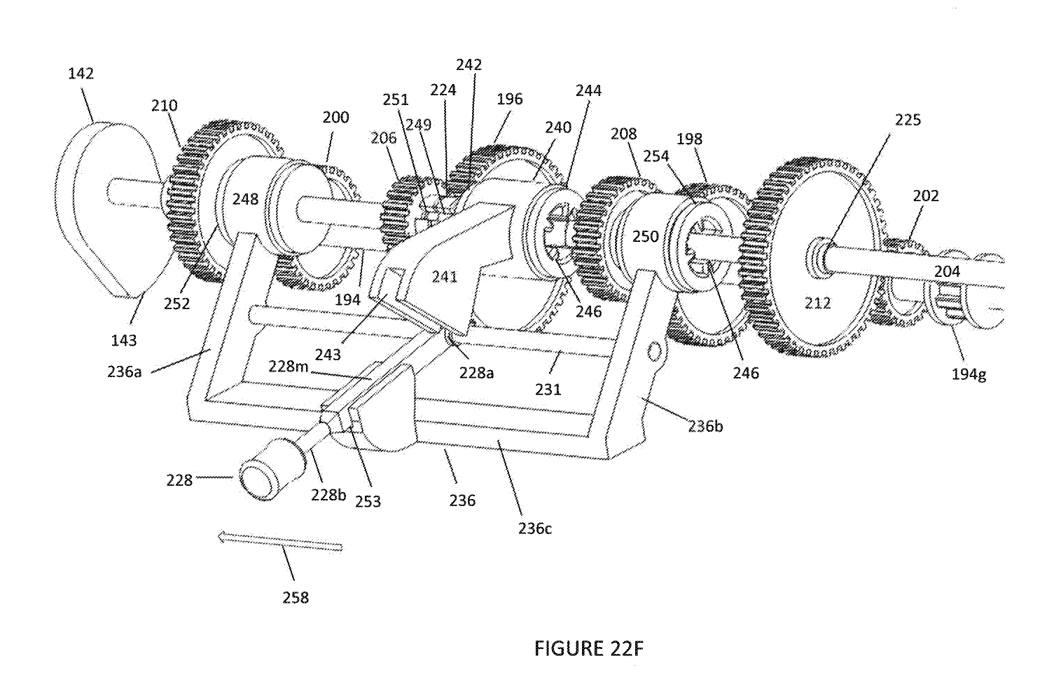

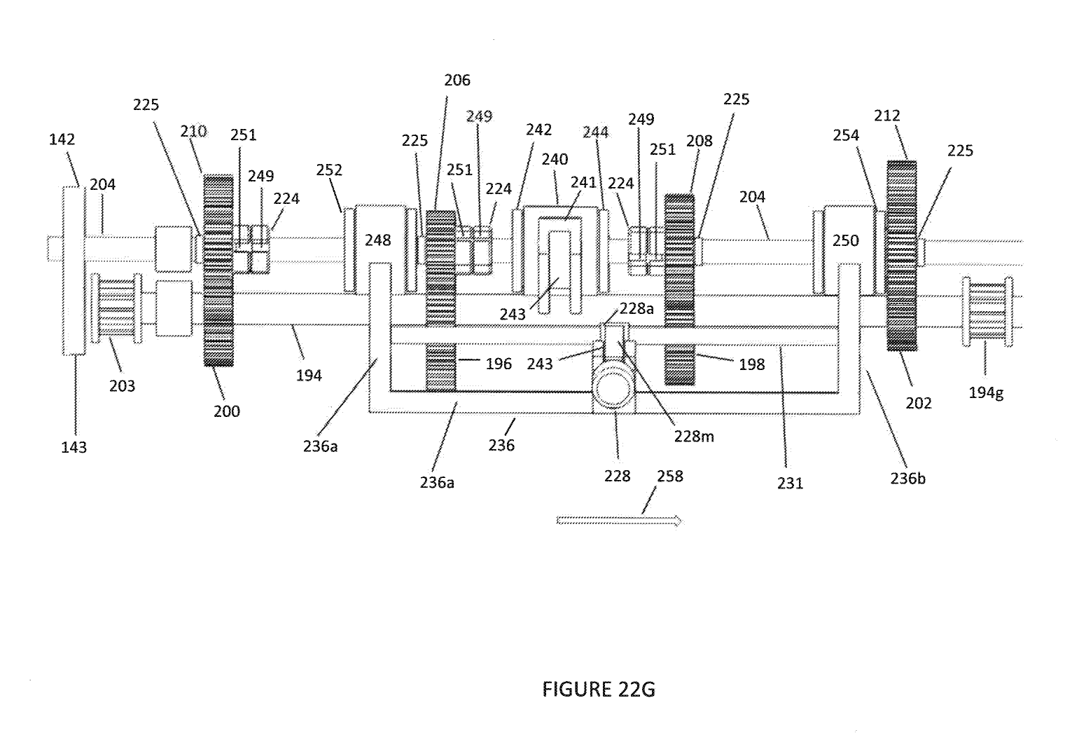

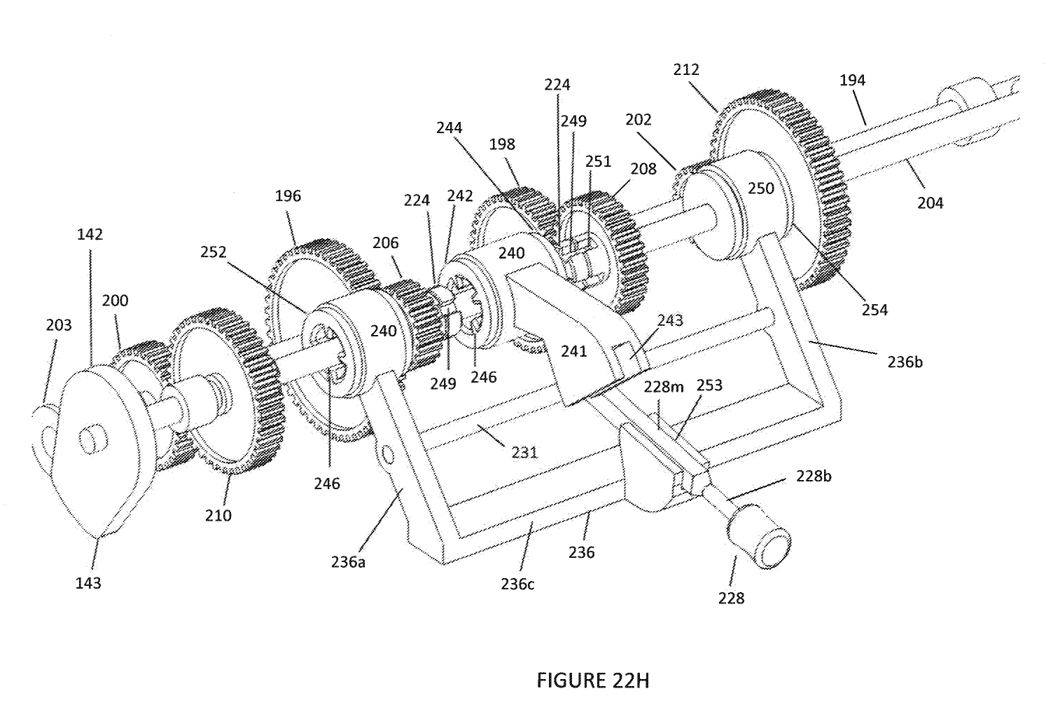

FIGS. 22A and 22B illustrate displacing the key collars 242, 244 in the direction indicated by arrow 258 when the shift handle 228 is moved along the upper horizontal slot 230-u to the “SMALL” position as shown in FIG. 21A. The keys 246 of the key collar 242 engage the collar keyways 249 of the fixed collar 224 associated with the cam shaft transmission gear 206, as well as the gear keyway 251 of the cam shaft gear 206. This engages the cam shaft transmission gear 206 with the cam shaft 204. Since the roller drive shaft gear 196 is constantly driving cam shaft gear 206, this engagement rotates the cam shaft at a rotation rate in accord with the ratio of the gear pair 196 & 206, which provides for the highest selectable cam rotational speed ω_{cam} for accommodating the shortest segment 91. With reference to FIGS. 22C and 22D, by moving the shift handle 228 along the upper horizontal slot 230-u to the “MEDIUM” (FIG. 21B) position the gear pair 198 & 208 becomes engaged by placement of the keys 246 of the key collar 244 the collar keyways 249 of the fixed collar 224 associated with the cam shaft transmission gear 208, as well as the gear keyway 251 of the cam shaft gear 208. This engages the cam shaft transmission gear 208 with the cam shaft 204. Since roller drive shaft gear 198 is constantly driving cam shaft gear 208, this engagement rotates the cam shaft at a rotation rate in accord with the ratio of the gear pair 198 & 208. The ratio of the gears 198 and 208 provides a somewhat longer cycle period for the cam 142, and thus a segment 91 of slightly longer length 98 than is produced when the size selector handle 228 is in the “SMALL” position.

In order to set the system size to “LARGE” OR “EXTRA LARGE” which results in relatively slower rotational speeds of the cam shaft 204 (thereby increasing the period of the cycle of the cam 142 and hence increasing the length 98 of the segments 91), the size selector handle 228 is moved downward along the vertical slot 230-v to the lower horizontal slot 230-1 for engagement within the slotted opening 253 of the bracket 236 (FIG. 21C and FIG. 21D). To select a “LARGE” setting the shift handle 228 is moved to the left, causing the U shaped key collar bracket 236 and key collar housings 248, 250 to slide to the left along the cam shaft 204 (FIGS. 22E and 22F). This engages the gear pair 200 & 210 in a manner similar to the above described engagement of other pairs of gears so that cam shaft 204 and cam 142 rotate at a rate slower than when in the “MEDIUM” position. This speed is suitable for large sized segments 91 used when the platform 12 is set to the “LARGE” position. Similarly, if a setting of “EXTRA LARGE” is selected the shift handle 228 is moved to the right, displacing the U shaped key collar bracket 236 and key collar housings 248, 250 to the right along the cam shaft 204 (FIGS. 22G and 22H). so that the gears 202 & 212 become engaged in a manner similar to the above described engagement of other pairs of gears so that the cam shaft 204 and cam 142 rotate at an even slower rate than when in the “LARGE” position. This speed is suitable for extra large sized segments 91 used when the platform 12 is set to the “EXTRA LARGE” position.

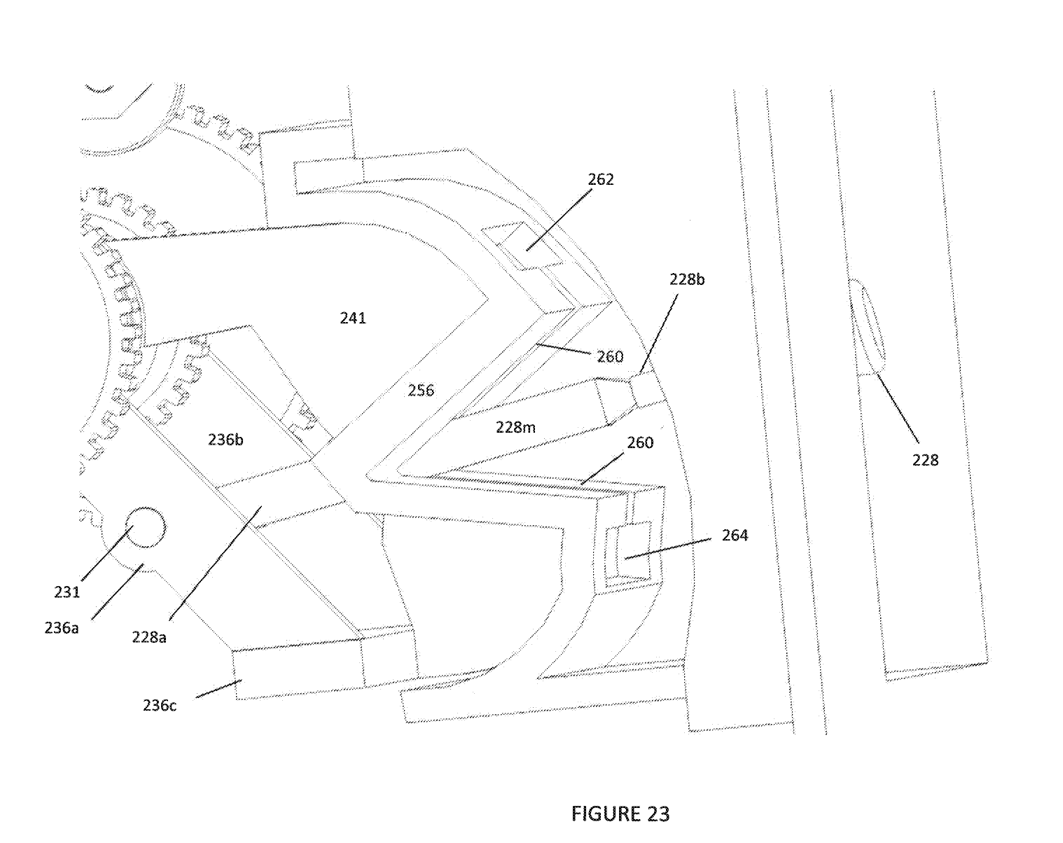

With reference to FIG. 23, the transmission further includes a frame 256 in which the single arm key collar bracket 241 and the U shaped key collar bracket 236 are mounted. The frame fixes the positions of the brackets 241, 236 relative to one another about the axis of the cam shaft 204. The frame 256 includes a neutral guide groove 260 which is aligned with the vertical slot 230-v of the guide plate 232 such that the shift handle travels along the groove 260 as it moves between the upper horizontal slot 230-u and the lower horizontal slot 230.

Shift handle 228 extends through an “H” pattern of connected slots 230 formed in a guide plate 232. The connected slots include an upper horizontal slot 230-u, a lower horizontal slot 230-1 and a extending between the horizontal slots. The frame 256 further includes a Small-Medium setting slot 262 and a Large-Extra Large setting slot 264. The Small-Medium setting slot 262 guides movement of the shift handle 228 and the single arm key collar bracket 241 along the upper horizontal slot 230-u between the Small and the Medium positions. The Large-Extra Large setting slot 264 guides the size selector handle 228 and the size selector second fixing assembly 236 between the “Large” and the “Extra Large”.

An embodiment of the invention has been described which utilizes a combination of a transmission 192, a platform adjustable in length to accommodate pets of different sizes, and rolls 16r, 20r of substrates which are available in different sizes suitable, each size for use with a different platform length. The ability to vary the size of the system 10 automatically generates sealed packages or bags 32 for any selected platform size. More generally, there has been disclosed a system which automatically seals deposited animal waste into sealed packages which can be retained until a caregiver is able to dispose of them. The disclosed illustrations of the system 10 are an exemplary implementation of the inventive concepts that variations of such a system could be employed to accomplish the same task while remaining within the scope of the invention.

Systems according to the invention may include one or more of the following features: A platform adjustable in length to accommodate pets of varied size; an automatic adjustment mechanism which adapts the system to accommodate receiving substrates of varied size as need be to conform with a selected platform length; a mechanism for creating a first pair of spaced-apart seals along a first direction and a second pair of spaced-apart seals along a second direction transverse to the first direction; a bag defined in accord with the pairs of spaced-apart seals; and a sensor switching mechanism which may, for example, be a weight sensor, that operates the system in response to a pet first standing on the platform and then walking off of the platform. Operation of systems according to the invention is based on recognition that a pet can stand over an area of the platform in order for waste to be deposited on the portion of the receiving substrate positioned over that area of the platform and will subsequently leave the platform area. A change in output from the weight sensor triggers system operation to convey the receiving substrate and the cover substrate so that the portion of the receiving substrate on which waste is deposited moves toward an area of the system where that portion of the receiving substrate and a portion of the cover substrate are bonded together to form a bag with the pairs of seals to completely seal the waste within the bag.

While various embodiments of the present invention have been described, such embodiments are provided by way of example only. Numerous variations, changes and substitutions may be made without departing from the spirit of the invention. Accordingly, the invention is only limited by the scope of the claims which follow.

The invention claimed is:

1. An apparatus for packaging animal waste, comprising:
a platform having a single and continuous receiving region surface over which waste may be deposited;
a pair of spaced apart rollers, each roller positioned along an edge of the platform (i) to receive, between each roller and along the entire receiving region surface, as the rollers turn, a receiving substrate having first and second opposing edge regions and (ii) to receive a cover substrate also having first and second opposing edge regions;
a first mechanism positioned to dispense the receiving substrate for movement across the platform to the rollers;
a second mechanism positioned to dispense the cover substrate for movement to the rollers without the cover substrate moving along the receiving region; and
wherein each roller is positioned to simultaneously receive the edge regions of both the receiving substrate and the cover substrate as the rollers turn and press the edge regions of the cover substrate against the edge regions of the receiving substrate to bond the edge regions together.

2. The apparatus of claim 1, wherein the rollers operate to create a seal between each edge region of the receiving substrate and a respective edge region of the cover substrate without extending the seal to regions of the receiving substrate which are between the rollers.

3. The apparatus of claim 1, wherein the rollers are each positioned to press the edge regions of the receiving substrate and the cover substrate against a portion of the platform while not pressing together portions of the receiving substrate and the cover substrate which are between the edge regions.

4. The apparatus of claim 1, wherein the rollers are powered rollers and effective to draw the receiving substrate across the platform.

5. The apparatus of claim 1, wherein:
the first mechanism is a first dispenser which holds the receiving substrate in the form of a rolled-up sheet which unrolls and moves along the platform as the rollers turn; and
the second mechanism is a second dispenser which holds the cover substrate in the form of a rolled-up sheet which unrolls and moves toward the rollers as the rollers turn.

6. The apparatus of claim 1, further comprising a repository into which the rollers direct the joined receiving and cover substrates.

7. The apparatus of claim 1, wherein the platform is adjustable in length along a direction of travel of the receiving substrate.

8. The apparatus of claim 7 wherein the platform is of a telescoping design with which members expand or contract the platform length.

9. The apparatus of claim 1, comprising a transverse pressing mechanism configured to periodically bond together a portion of the receiving substrate, between the receiving substrate edge regions, and a portion of the cover substrate between the cover substrate edge regions.

10. The apparatus of claim 9, wherein, during operation of the apparatus, the combination of the rollers and pressing mechanism act to create a continuous seal defining an enclosed chamber between portions of the receiving and cover substrates.

11. The apparatus of claim 9 wherein, during operation, the transverse pressing mechanism periodically bonds an entire width of the portion of the cover substrate between the cover substrate edge regions to an entire width of the portion of the receiving substrate between the receiving substrate edge regions.

12. The apparatus of claim 9, wherein the rollers are positioned to rotate about a common axis and the transverse pressing mechanism comprises a lobe disposed on the common axis, the lobe having an eccentric shape relative to the axis and extending a maximum radial distance from the common axis a radial distance equal to a radial distance which the rollers extend from the axis such that a ridge disposed along the lobe and extending the maximum radial distance turns about the axis as the rollers turn about the axis to periodically bond the portion of the cover substrate to the portion of the receiving substrate.

13. The apparatus of claim 9, wherein periodic motion is caused by a cam system comprising a rotatable cam and a rocker arm having a first end biased against an edge of the cam.

14. The apparatus of claim 13, comprising powered rollers, wherein the cam system is driven by a system motor that also drives the rollers.

15. The apparatus of claim 13, wherein a rotational period of the cam system is selectively adjustable with respect to a speed of a system motor.

16. A method for disposing of animal waste, comprising:
providing a segment of first sheet material comprising a fluid absorbent region formed on a first fluid impermeable substrate;
providing a segment of second sheet material comprising a second fluid impermeable substrate;
receiving animal waste in the fluid absorbent region of the first sheet material; and
sealing outer edge regions of the first sheet material with outer edge regions of the second sheet material, while not pressing together a middle region of the first sheet material between the outer edge regions and a middle region of the second sheet material between the outer edge regions, effective to enclose the animal waste between the first sheet material, the second sheet material, and the outer edge regions.

17. The method of claim 16, further including:
positioning the segment of first sheet material in a first location where the animal waste is received in the fluid absorbent region of the first sheet material; and
after the animal waste is received, moving the first sheet material from the first location to a position where the outer edge region of the first sheet material contacts the outer edge region of the second sheet material.

18. The method of claim 16, comprising removing the segment of first sheet materials from the platform to seal the outer edge regions while providing a new segment of first sheet material on the platform for subsequent use.

19. A packaging system for receiving pet excrement useful with an apparatus which positions components of the system to receive and enclose the pet excrement in isolation from the surrounding environment, the apparatus including a platform having first and second sides along which a component of the system can be movably positioned to receive the pet excrement and carry the pet excrement along the platform, the system comprising:
a first roll of fluid impermeable material of predetermined length and width, the first material having first and second opposing side regions extending along the length of the first material wherein the width, which extends across the first material from an edge of the first side region to an edge of the second side region, is suitable for movement of each side region along a different one of the first and second sides of the platform; and
a second roll of fluid impermeable material of predetermined length and width, the second material having third and fourth opposing side regions extending along the length of the second roll wherein the width, which extends across the second material from an edge of the third side region to an edge of the fourth side region, is suitable to effect placement of the first side region along a portion of the first material against the third side region along a portion of the second material and placement of the second side region along the portion of the second material against the fourth side region along the portion of the second material wherein, when the first side region and the third side region are pressed against one another a seal is created between the first and third side regions and when the second side region and the fourth side region are pressed against one another a seal is created between the second and fourth side regions,
wherein the first material comprises a series of spaced apart middle regions each extending between (and to) the first and second opposing side regions,
wherein the second material comprises a series of spaced apart middle regions each extending between (and to) the third and fourth opposing side regions and positioned for contact with a middle region of the first material, and
wherein when each middle region in the first series is pressed against a middle region in the second series a transverse seal is created between one middle region in the first series and one middle region in the second series such that after two such transverse seals are created, the first and second materials are bonded to one another to form a sealed region between the two middle regions suitable for containing the pet excrement and which provides a seal which physically isolates pet excrement contained in the sealed region from the surrounding environment.

20. The system of claim 19, wherein the first material comprises a series of spaced apart middle regions each extending between the first and second opposing side regions, wherein the second material comprises a series of spaced apart middle regions each extending between the third and fourth opposing side regions and positioned for contact with a middle region of the first material, and wherein, when each middle region in the first series is pressed against a middle region in the second series so a transverse seal is created between one middle region in the first series and one middle region in the second series such that after two such transverse seals are created, the first and second materials are bonded to one another to form a sealed region between the two middle regions to contain the pet excrement and provide a seal which physically isolates the pet excrement from the surrounding environment.
